(19) United States
(12) Patent Application Publication
(10) Pub. No.: US 2006/0047697 A1
(43) Pub. Date: Mar. 2, 2006

(54) Microarray database system

(76) Inventors: Tyrell Conway, Norman, OK (US); Joe Grissom, Moore, OK (US); Jilin Han, Norman, OK (US); Jonathan Wren, Norman, OK (US); Minghua Yao, Norman, OK (US); Marybeth Langer, Norman, OK (US); Matt Traxler, Norman, OK (US); Dong E. Chang, Murfreesboro, TN (US)

Correspondence Address: DUNLAP, CODDING & ROGERS P.C., PO BOX 16370, OKLAHOMA CITY, OK, 73113, US

(21) Appl. No.: 11/196,920

(22) Filed: Aug. 4, 2005

Related U.S. Application Data
(60) Provisional application No. 60/598,914, filed on Aug. 4, 2004.

(51) Int. Cl. G06F 17/00

(52) U.S. Cl. 707/103 R

(57) ABSTRACT

A microarray database (MDB) system for providing a computer-based environment for storing, managing and interconnecting comprehensive information associated with various aspects of microarray research for a plurality of users, including microarray design and production, sample production, hybridization, data recordation, data retrieval, data analysis, and data presentation. As such, the MDB system gives users the ability to relate information describing array production, experimentation, and analysis, including all the experiment parameters, hybridization results, and analysis results. The MDB system includes a server and database accessible by users via a user system, and provides users with a user interface to input, store, manage, retrieve, process, analyze, display and/or output data relating to microarray experiments. The user interface prompts and guides users through a step-by-step process for creating data entries and keeping records in the MDB system, and is designed prevent users from making invalid entries or entering data in the wrong order.

### CROSS-REFERENCE TO RELATED APPLICATIONS

The present application claims priority to the provisional application identified by the U.S. Ser. No. 60/598,914, filed on Aug. 4, 2004, the entire content of which is hereby expressly incorporated herein by reference.

### STATEMENT REGARDING FEDERALLY SPONSORED RESEARCH OR DEVELOPMENT

The present invention was made with partial support from the National Science Foundation Grant No. EPS-0132534 and the National Institutes of Health Grant No. RR-01-005.

### BACKGROUND OF THE INVENTION

DNA microarrays have a large and growing role in life sciences research.

They are used extensively in experiments to determine the levels of mRNA expression in a sample being tested, and as such allow the DNA or genes of the sample to be sequenced.

In general, a microarray used in such experiments includes a plurality of oligo spots which contain DNA. The spots are disposed on a substrate (e.g., a slide or tray), and are preferably ordered in an array or grid formation. Preferably, each spot of the microarray is provided with a unique DNA sequence. In other words, each spot has a different DNA sequence than the other spots in the microarray. Because each spot will hybridize only to its complementary DNA strand, when each spot is probed by the sample being tested, the interaction therebetween can be used to determine the level at which complementary DNA is present in the sample being tested (and thus is indicative of the mRNA or gene sequence for the sample).

To prepare the sample probe, the mRNA material of the sample, or its equivalent, is isolated and then labeled with a dye, e.g., a fluorescent reporter group. The labeled mRNA sample is then combined with the spots of the microarray to form hybridization complexes between the spot materials and the mRNA materials that have complementary or identical sequences. Any formed complexes are detected by using a scanner or like device to measure fluorescent signals emitted from specific spots in the microarray. Since the position of each spot and the sequence of its material are known, those spots emitting fluorescent signals are indicative of the mRNA of the sample being tested. Due to the number of spots that can be provided in the microarray and experimented with in parallel, observations can be made on a whole-genome scale.

Since microarrays are used to address biological problems on a whole-genome scale, microarray applications are generally voluminous and computationally intensive. Also, working with data relating to microarray applications require various database utilities, such as for example those relating to microarray production, sample production, hybridization, process monitoring, data storage and retrieval, image analysis, statistical analysis, data mining, and graphical data presentation. Therefore, there is a need for an efficient, comprehensive and integrated computer-based microarray database system with diverse applications spanning the multiple steps of the microarray process. It is to such a system, and methods for implementing and using the same, that the present invention is directed.

### BRIEF DESCRIPTION OF THE DRAWINGS

FIG. 1 is a diagram of a microarray database system constructed in accordance with the present invention.

FIG. 2 is a block diagram of one embodiment of an Array Production Management application of the microarray database system.

FIG. 3 is an exemplary print run list table displayable in a user interface of the microarray database system.

FIG. 4 is an exemplary array design info table displayable in the user interface of the microarray database system.

FIG. 4 is an exemplary plates list table displayable in the user interface of the microarray database system.

FIG. 5 is an exemplary plate info table displayable in the user interface of the microarray database system.

FIG. 6 is an exemplary gene annotation table displayable in the user interface of the microarray database system.

FIG. 8A is a flow diagram of one embodiment of a create function for inputting experimental information for an experiment in a Laboratory Information Management System application of the microarray database system.

FIG. 8B is a flow diagram of another embodiment of the create function, which is truncated for inputting experimental information for replicate experiments in the Laboratory Information Management System application.

FIG. 9 is a block diagram of one embodiment of the Laboratory Information Management System application of the microarray database system.

FIG. 10A is an exemplary table for biosample protocol information displayable in the user interface of the microarray database system.

FIG. 10A is an exemplary table for biosample protocol information displayable in the user interface of the microarray database system.

FIG. 10B is an exemplary table for extract protocol information displayable in the user interface of the microarray database system.

FIG. 10C is an exemplary table for label protocol information displayable in the user interface of the microarray database system.

FIG. 10D is an exemplary table for hybridization protocol information displayable in the user interface of the microarray database system.

FIG. 10E is an exemplary table for biosample source information displayable in the user interface of the microarray database system.

FIG. 10F is an exemplary table for biosample information displayable in the user interface of the microarray database system.

FIG. 10G is an exemplary table for extract sample information displayable in the user interface of the microarray database system.

FIG. 10H is an exemplary table for label sample information displayable in the user interface of the microarray database system.

FIG. 10I is an exemplary table for hybridization information displayable in the user interface of the microarray database system.

FIG. 11 shows one embodiment of a Create Label Sample input means of the Laboratory Information Management System application.

FIG. 12 shows one embodiment of a first window of a Create Replicates input means of the Laboratory Information Management System application.

FIG. 13 shows one embodiment of a second window of the Create Replicates input means of the Laboratory Information Management System application.

FIG. 14 is a block diagram of one embodiment of a Data Import application of the microarray database system.

FIG. 15 is an exemplary microarray image displayable in the user interface of the microarray database system.

FIG. 16 is an exemplary spot image and spot information table displayable in the user interface of the microarray database system.

FIG. 17 shows one embodiment of an upload means of the Data Import application.

FIG. 18 shows one embodiment of a Filter Feature input means and a Normalization Analysis Options input means of the Data Import Application.

FIG. 19 shows one embodiment of a Normalization Method input means of the Data Import application.

FIG. 20 is an exemplary correlation table displayable in the user interface of the microarray database system.

FIG. 21 shows one embodiment of a Two Samples Comparison Option input means of the Data Import application.

FIG. 22 shows an exemplary t-Statistic Analysis Results table displayable in the user interface of the microarray database system, and one embodiment of a t-statistic plot means of a Data Visualization application of the microarray database system.

FIG. 23 shows an exemplary Linear Model and Empirical Bayes Analysis Results table displayable in the user interface of the microarray database system, and one embodiment of a Linear Model and Empirical Bayes plot means of the Data Visualization application.

FIG. 24 is a block diagram of one embodiment of a Data Visualization application of the microarray database system.

FIG. 24A shows one embodiment of a Plot Options input means of the microarray database system.

FIG. 25 is an exemplary data analysis results table which is sortable and displayable in the user interface of the microarray database system

FIG. 26 shows one embodiment of a Data Analysis Option input means of the microarray database system.

FIG. 27 shows one embodiment of a Experiment Results access means for an exemplary experiment.

FIG. 28 shows an exemplary Experiment List displaying at least a portion of the Experiment Results access means for a plurality of exemplary experiments.

FIG. 29 is a block diagram of a modular layout of an example microarray database system.

FIG. 30 shows an exemplary gene query box and project list displayed in a user interface of the example microarray database system.

[FIGS. 31A-31B show an exemplary data plot according to statistical confidence intervals selectable in the user interface.

FIG. 32 shows an exemplary hierarchial cluster for an experiment set displayed in the user interface.

FIG. 33 shows an exemplary heat map displayed in the user interface.

FIG. 34 shows an exemplary genome view and snapshot displayed in the user interface.

FIG. 35 shows an exemplary log ratio vs. time point plot displayed in the user interface.

FIG. 36 shows an exemplary heat map, annotation table and metalinks table displayed in the user interface.

FIG. 37 shows an exemplary ratio graph displayed in the user interface.

FIG. 38 shows an exemplary metabolic pathway chart displayed in the user interface.

FIG. 39 shows an exemplary download means displayed in the user interface.

FIG. 40 shows an exemplary filter displayed in the user interface.

FIG. 41 shows an exemplary data display displayed in the user interface.

FIG. 42 is a block diagram of a Production Data Schema for the example microarray database system.

FIG. 43A is an exemplary data analysis pipeline means displayed in the user interface.

FIG. 43B is an exemplary experimenters list displayed in the user interface.

FIG. 43C is an exemplary project list displayed in the user interface.

FIG. 43D is an exemplary experiment sets list displayed in the user interface.

FIG. 43E is an exemplary replicates list, normalization means, and filter means displayed in the user interface.

### DETAILED DESCRIPTION

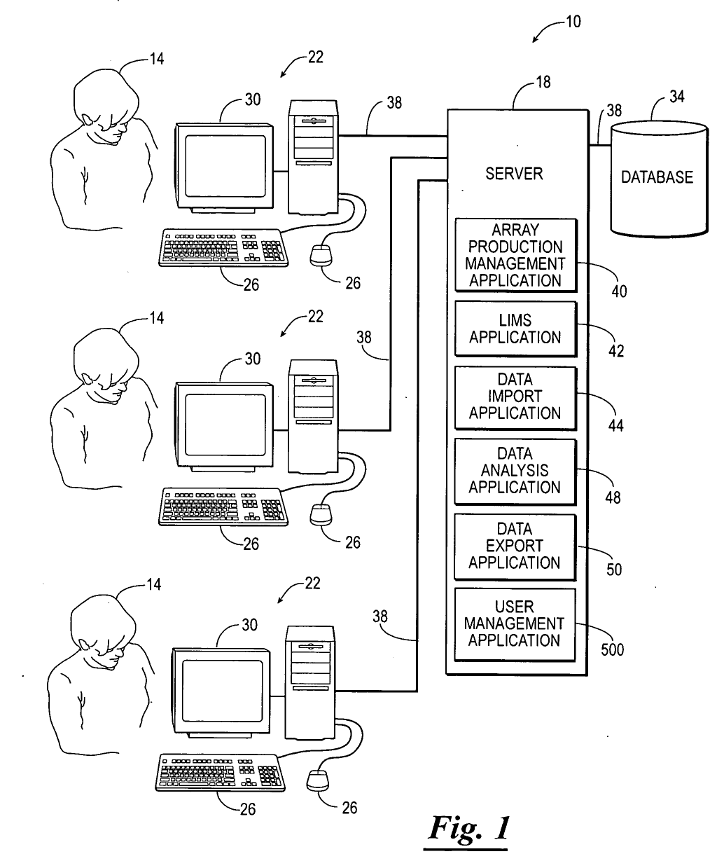

Referring now to the drawings, and in particular to FIG. 1, shown therein and labeled by the reference numeral 10 is a microarray database (MDB) system constructed in accordance with the present invention. In general, the MDB system 10 is a computer-based environment for collecting, storing, managing, integrating and interconnecting (or linking) comprehensive information associated with various aspects of microarray research for a plurality of users 14. Such aspects include microarray design and production, sample production and labeling, hybridization, experiment results recordation and processing, analysis and graphical presentation, for example. Further, the MDB system 10 is preferably constructed so as to allow such functionality in conformity with the international microarray community standard MIAME (Minimum Information About a Microarray Experiment).

As shown in FIG. 1, the MDB system 10 of the present invention includes a server 18. The server 18 includes one or more computer systems (not shown). For example, the server 18 can include one or more general computers having a central processor unit (CPU), an I/O unit, and a memory that stores data and various programs such as an operating system and other software and application programs (as discussed further below). The server 18 may also include a communication device (not shown) for exchanging data (e.g., a satellite receiver, a modem, or network adapter).

The server 18 is in communication with a plurality of user systems 22. In general, each of the user systems 22 is a computer system associated with one of the users 14. Each user 14 utilizes its user system 22 to transmit information to and receive information from the server 18 of the MDB system 10. The term “transmit,” and derivations thereof, as used herein generally means to pass or to send.

Preferably, each user system 22 includes at least one output device 26 (e.g., a monitor, display, screen, speaker, or printer) and at least one input device 30 (e.g., a keyboard, mouse, keypad, joystick, microphone, or touch-screen). Further, each user system 22 preferably operates a web-browser or other program which allows for the retrieving and viewing of electronic information via the Internet and/or the World Wide Web.

The server 18 of the MDB system 10 is also in communication with a database 34. In general, the database 34 is used for storing microarray research information or data which is accessible by the server 18. In one embodiment, the database 34 is a relational database, such as for example an Oracle 9i database. Generally, the database 34 is stored on a storage media in a storage device (not shown), such as a hard disk drive for example. Also, the database 34 can be local to or remote from the server 18.

In one embodiment, the server 18 is established on the Internet so as to be publically available. For example, the server 18 can include a web server computer system, such as an Apache web server computer system, which hosts a website on the World Wide Web so that the server 18 can be accessed using http: protocol. The users 14 can then utilize their corresponding user systems 22 to initiate a web browser and connect to the server 18 via the website. The establishing of a computer system and websites on the Internet and/or World Wide Web are known to those skilled in the art and therefore no further discussion is deemed necessary to teach one skilled in the art how to establish the server 18 of the MDB system 10 on the Internet and/or the World Wide Web.

The server 18 communicates with the user systems 22 and the database 34 via communication links 38. The communication links 38 can be any suitable communication link which permits electronic communications, such as such as extra computercommunication systems, intra computer communication systems, internal buses, local area networks, wide area networks, Internet networks, point to point shared and dedicated communications, infra red links, microwave links, telephone links, cable TV links, satellite links, radio links, fiber optic links, cable links and/or any other suitable communication device, system or network, or combinations thereof. Preferably, the communication links 38 between the server 18 and the user systems 22 are Internet based links which allows electronic information to be transferred between the server 18 and the user systems 22 via the Internet.

In operation, the server 18 of the MDB system 10 allows a user to input, store, manage, retrieve, process, analyze, display, output or otherwise utilize data relating to microarray experiments. To facilitate such operations, the server 18 provides a user interface to each user 14 via its user system 22. In one embodiment, the user interface is a web interface implemented with PHP, JavaScript, Java Applet, and HTML based programs. Further, the server 18 in one embodiment uses PHP server-side scripting language to create R scripts based on information received from the user systems 22 (e.g., user requests) and to transform information to be transmitted to the user systems 22 (e.g., analysis results and image files) into a web compatible format.

In general, the user interface is utilized to prompt and guide the user 14 through a step-by-step process for creating data entries and keeping records in the MDB system 10 for one or more microarray experiments. Preferably, the logical progression of data entry flow via the user interface is designed from the user's perspective. Also, the data entry design of the user interface is preferably constructed so as to generally prevent a user 14 from making invalid entries or entering data in the wrong order. This prevents data from being entered haphazardly from any point during the process, and thus users 14 cannot hastily or inadvertently gloss over data details. Rather, the data is complete and consistent in format from experiment to experiment. Maintaining such order and uniformity in the recording keeping process prevents future confusion for other users 14 (e.g., other scientists or managers) when reviewing experiment details. Various embodiments of the user interface is described in further detail below with reference to the various applications of the MLB system 10.

Because the operation of the MLB system 10 is similar for each user 14, for purposes of brevity and clarity of understanding, the MLB system 10 is generally discussed herein with reference to one of the users 14 and its corresponding user system 22. Also, because operation of the MLB system 10 is similar for each microarray for which an experiment is performed and information is included in the MLB system 10, the MLB system 10 is generally discussed herein with reference to one microarray. From the discussions with reference to the one user 14 and the one microarray, it should be apparent to those of ordinary skill in the art how to construct and apply the MLB system 10 for a plurality of users 14 and/or a plurality of microarrays.

In one embodiment, the server 18 of the MLB system 10 has an “Array Production Management” application 40, a “Laboratory Information Management System” (LIMS) application 42, a “Data Import” application 44, a “Data Analysis” application 48, and a “Data Export” application 50, as shown in FIG. 1. In general, the Array Production Management application 40 is used to track information relating to microarrays before any experimentation has been conducted; the LIMS application 42 is used to track information relating to samples and hybridization processes used to hybridize microarrays; the Data Import application 44 is used to import and process experiment results for hybridized microarrays; the Data Analysis application 48 is used to generate graphical presentations of experiment and analysis results; and the Data Export application 50 is used to export information, such as for example experiment results or analysis results. Each of these applications will now be discussed in further detail.

As mentioned above, the Array Production Management application 40 of the present invention is, in general, used to track information relating to microarrays before any experimentation has been conducted. More particularly, the Array Production Management application 40 of the present invention is used to receive, store and manage array information associated with the production or printing of experimental microarrays, which is also referred to herein as spotting run information. Spotting run information can include aspects of array design, probe formation, plate source information, microarray spot locations, printing chemistry, print-run information, array printer configuration, and gene annotation for the microarray, for example.

Generally, spotting run information is unique because the DNA oligo spots of a microarry and the date and time of creation, taken together, are not duplicated. As such, the spotting run information can provide a unique access point or identifier which can be used to link to other aspects of information associated with the microarray within the MDB system 10. Further, each individual DNA oligo spot can be used to link to specific information associated with that particular spot in the microarray. As such, in one embodiment of the present invention, the DNA oligo spots are used as a “starting point” to create entries wherein data can be uploaded and stored in the MDB system 10 (even before such data has been created and made available).

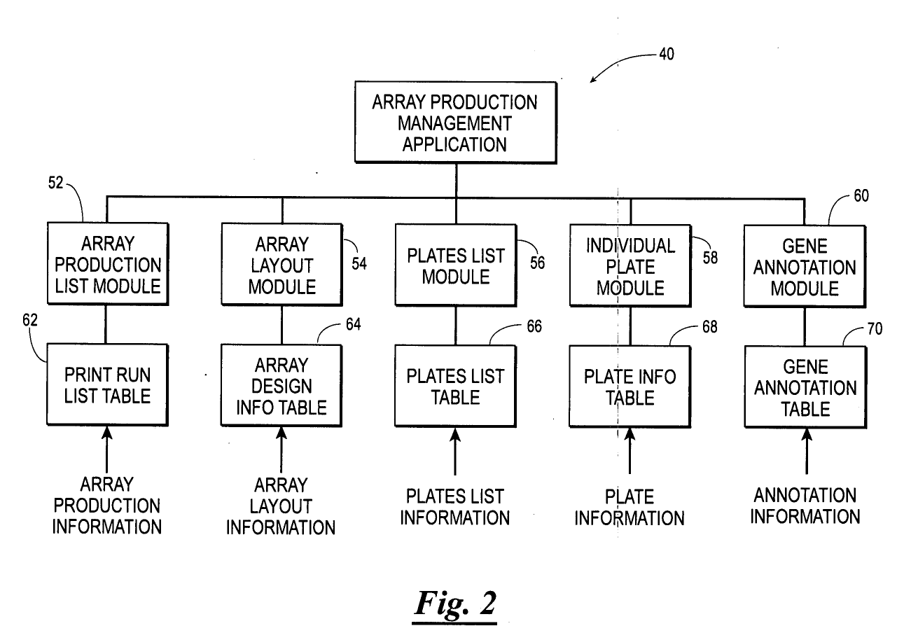

In one embodiment, the Array Production Management application 40 includes an “Array Production List” module 52, an “Array Layout” module 54, a “Plates List” module 56, an “Individual Plate” module 58, and a “Gene Annotation” module, as shown in FIG. 2.

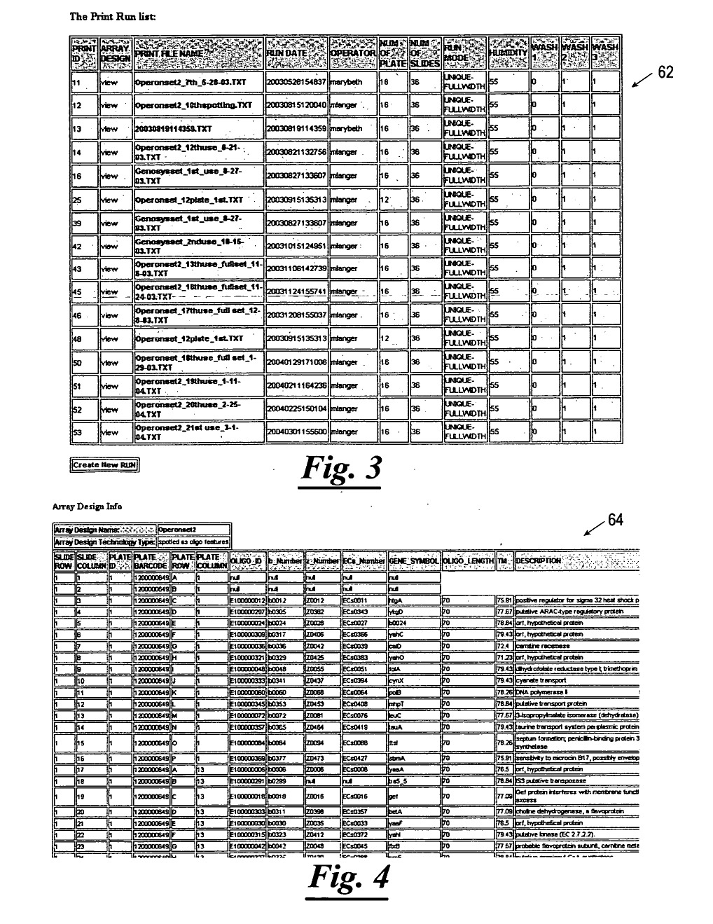

Within the Array Production List module 52, array production information is received and stored in a “Print Run List” table 62 having a plurality of data entry fields which can be displayed via the user interface to the user 14, as shown for example in FIG. 3. One of the data entry fields of the Print Run List table 62 is a “Print ID” field, which provides a number identifier for a particular spot run. An “Array Design” field provides a link to a view of a graphical representation of the array design. A “Print File Name” field provides a name for a file used to generate the spot run (such as for example a file that was provided as input to a microarray printer so that the microarray could be printed in accordance with the instructions contained within the file). A “Run Date” field provides the date on which the microarray was produced. An “Operator” field provides the identity of the entity or person who caused the production of the microarray. A “Num of Plate” field provides the number of plates used in the production of the microarray. A “Num of Slides” provides the number of slides used in the production of the microarray. A “Run Mode” field provides the mode in which the microarray was produced (e.g., a unique run spanning the fullwidth of the microarray). A “Humidity” field provides the humidity when the microarray was produced. A “Wash 1” field provides the number of times a first wash was applied to the microarray during production, a “Wash 2” field provides the number of times a second wash was applied to the microarray during production, and a “Wash 3” field provides the number of times a third wash was applied to the microarray during production.

Within the Array Layout module 54, array layout information relating to the correspondence between plates and array location is received and stored in an “Array Design Info” table 64 having a plurality of data entry fields, which can be displayed to the user 14 via the user interface as shown for example in FIG. 4. A “Slide Row” field of the Array Design Info table provides a slide row number, and a “Slide Column” field provides a slide row column, thereby collectively providing an identifying coordinate of a spot on a slide in the array design. A “Plate ID” field provides a plate number identifier for a particular plate in the array design. A “Plate Barcode” field provides a bar code number uniquely identifying the plate. A “Plate Row” field provides a plate row number, and a “Plate Column” field provides a plate column number, thereby collectively providing an identifying coordinate of the printing material (oligo) in the plate. An “Oligo_ID” field provides an oligo identifier for a particular spot. An “b_number” field provides a b number for the spot. A “z_number” field provides a z number for the spot. An “Ecs_number” provides an ecs number for the spot. A “Gene_Symbol” field provides the gene name for the spot. An “Oligo_Length” field provides a length of the oligo. A “TM” field provides a melting temperature for the oligo. And a “Description” field contains a general description for the spot material.

Further, as shown in FIG. 4, to provide information relating to the collective array layout in the Array Design Info table 64, the Array Layout module 54 can include an “Array Design Name” field which provides a name assigned to the array design for the array layout, and an “Array Design Technology Type” field which provides the technology type (e.g., spotted oligo features) used in the array design for the array layout. Also, the Array Layout module 54 can receive and store platform information relating to the array platform. For example, the platform information can include a name, number or other identifier of the platform, and notes or description for the platform.

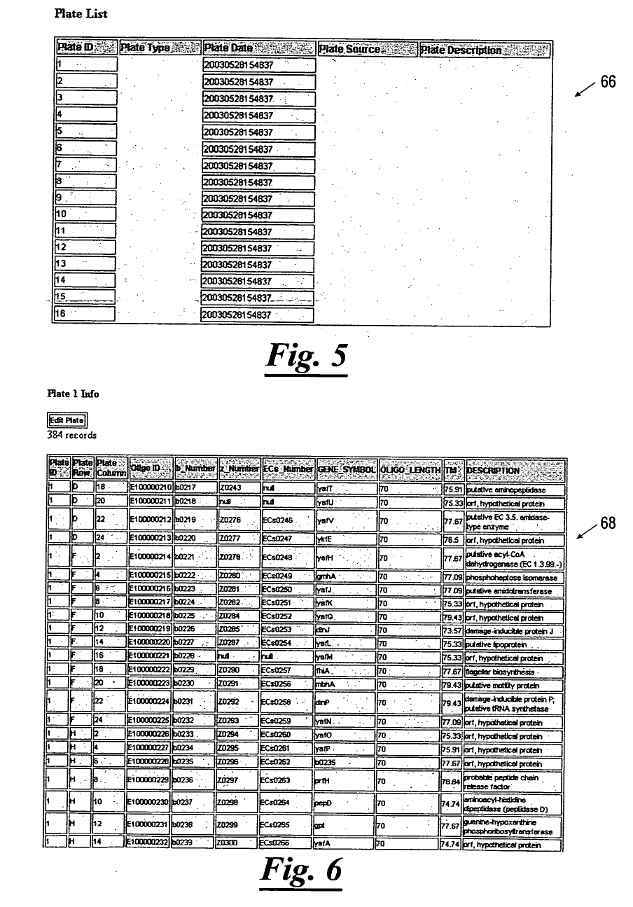

Within the Plates List module 56, plate list information relating to a list of plates in the microarray is received and stored in a “Plate List” table 66 having a plurality of data entry fields, which can be displayed to the user 14 via the user interface, as shown for example in FIG. 5. The Plate List table 66 includes a “Plate ID” field which provides the number identifier for a particular plate in the array design. A “Plate Type” field provides the plate type for the plate. A “Plate Date” field provides the date the plate was produced or received from the manufacturer. A “Plate Source” field provides a source of the plate. A “Plate Description” provides a description of the plate.

Within the Individual Plate module 58, plate information for each individual plate in the plate list is received and stored in a “Plate Info” table 68 for that plate (only one being shown in FIG. 6 for purposes of brevity). The Plate Info table 68 for each plate has a plurality of data entry fields, and can be displayed to the user 14 via the user interface, as shown for example in FIG. 6 for a first plate and labeled therein by the title “Plate 1 Info”. From the discussion for one plate, one of ordinary skill in the art should understand how to construct the Plate Info table 68 for other plates in the plate list.

The Plate Info Table 68 includes a “Plate ID” field which provides the plate number identifier for the plate. A “Plate Row” field provides the plate row number, and a “Plate Column” field provides the plate column number. An “Oligo_ID” field provides an oligo identifier for the oligo in a well of the plate. An “b_number” field provides a b number for the oligo in a well of the plate. A “z_number” field provides a z number for the oligo in a well of the plate. A “Ecs_number” provides an ecs number for the oligo in a well of the plate. A “Gene_Symbol” field provides the gene symbol for the oligo in a well of the plate. An “Oligo_Length” field provides a length of the oligo in a well of the plate. A “TM” field provides the melting temperature for the oligo in a well of the plate. And a “Description” field contains a general description for the plate.

Within the Gene Annotation module 60, annotation information for the annotation of genes associated with the microarray is received and stored in an “Gene Annotation” table 70 having a plurality of data entry fields, which can be displayed to the user 14 via the user interface as shown for example in FIG. 7. In the Gene Annotation table 70, a “Mbnum” field provides the b_number. An “ArrayCoordinate” field provides the field, row and column location for that oligo. A “Ecogeneb” field provides the Ecogene b_number. An “Ecogene” field provides an Ecogene name. An “EG12protb” field provides the Ecogene b_number. A “Swissprot” field provides the p_number. A “Quality” field provides a quality check for the oligo. An “AA” field provides the number of amino acids in the gene product. An “Eg12prot-eg” field provides the Ecogene protein number for the gene product. A “M54Gene” field provides the gene name. An “EcogeneName” field provides the gene name. An “Orientation” field provides the direction of the gene on the genome. An “ArrayAnnotationB” field provides the b_number. An “Accession-NA” field provides the nucleotide accession number. An “Accession-AA” field provides the protein accession number. An “IntragenicLength” field provides the distance between genes in the operon. A “LeftEnd” field provides the left start point for the gene. A “RightEnd” field provides the right start point for the gene. A “GeneProduct” field provides the gene product. An “OrigFunctionalGroup” field provides the functional group. A “RevFunctionalGroup” field provides the functional group. A “Known Reg DB” field provides the known operon arrangements. A “directionRegDB” field provides the direction of the operon on the genome. An “OperonRegDB” field provides the genes in the operon. A “M53Function” field provides the functional group. A “Notes” field provides additional information for the oligo.

In one embodiment, at least a portion of the array production information of the Array Production List module 52, the array layout information of the Array Layout module 54, the plate list information of the Plates List module 56, the plate information of the Individual Plate module 58, and/or the annotation information of the Gene Annotation module 60 of the Array Production Management application 40 are inputted by uploading one or more data files (e.g, spreadsheet files) containing such information. For example, for membrane and GeneChip arrays, data files are provided by the manufacturer and can be uploaded to the server 18, for example by the user 14 via the user system 22, or be otherwise made accessible to the server 18. However, it should be understood that the array information can be inputted in the Array Production Management application 40.

As mentioned above, the LIMS application 42 of the present invention is, in general, used to track information relating to samples and hybridization processes used to hybridize microarrays. More particularly, the LIMS application 42 is used to receive, store and manage experimental information relating to the microarray experimentation process, including information relating to the protocols that were followed, how particular samples were produced and treated (e.g, what organism and labeling materials were used), and the hybridization process, for example. As such, the LIMS application 42 of the MDB system 10 functions as a virtual or digital research notebook where records can be made in a uniform and consistent manner. Further, the LIMS application 42 can be used to manage and track probe source plates and printed microarrays (e.g., using barcode identifiers), and as such allows the MDB system 10 to function also as a material management system.

In one embodiment, the LIMS application 42 allows the user 14 to input experimental information for one or more experiments via the user interface in an automated process in order to save the user time in entering or importing data into the server 18. This process works for single or replicate experiments (where a plurality of replicates are generally preprocessed and averaged to make up a “single” experiment, i.e., a data set for a time point or treatment). However, the automated process is especially useful for importing information for replicate experiments.

In general, the user 14 is allowed to input information regarding a project and an experiment set with which an experiment is associated before proceeding with the details of the experimental process for the experiment. Such an organizational format corresponds to the intuitive levels of microarray experimentation. Also, because the LIMS application 42 organizes the information for microarrays in a logical, hierarchical format, it makes it easier for the users 14 to find projects, experiment sets, and experiment information. Further, if an experiment is a replicate, and thus can be associated with a pre-existing project or experiment set, the LIMS application 42 can automatically link repetitive information between experiment replicates. This eliminates the need for entering repetitive information by the user 14.

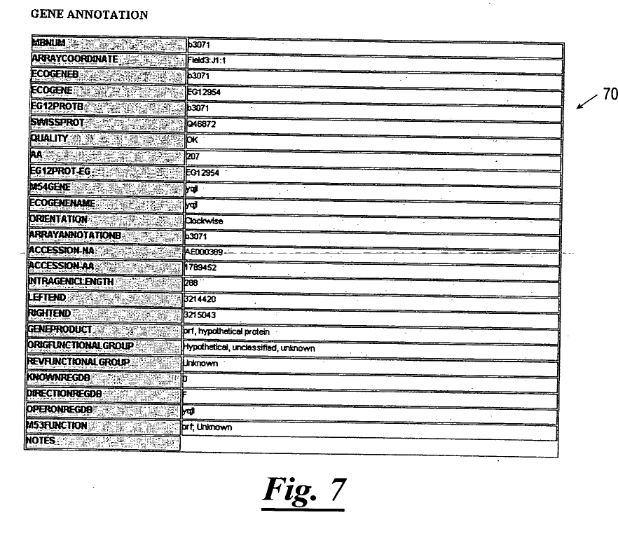

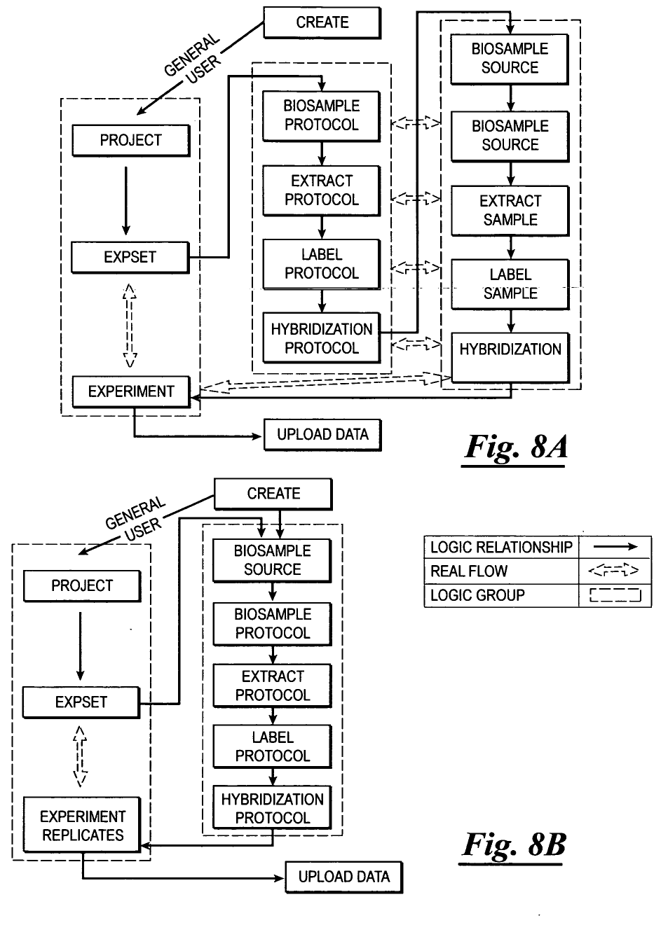

The automated process of the LIMS application 42 is referred to herein as a “Create” function. One embodiment of the flow of the Create function for a single or first experiment is shown in FIG. 8A. When replicate experiments are being created, the operation of the create function can be truncated since repetitive information can be inputted by selection from one or more pre-existing entries and/or can be automatically retrieved by the server 18 based on the relationship between a new replicate experiment and an existing experiment. For example, shown in FIG. 8A is one embodiment of the flow of the Create function for a replicate experiment.

For purposes clarity of understanding, the flow and operation of the Create function will first be described below with reference to a first experiment wherein all new information is inputted. Then the flow and operation of the Create function will be described with reference to replicate experiments.

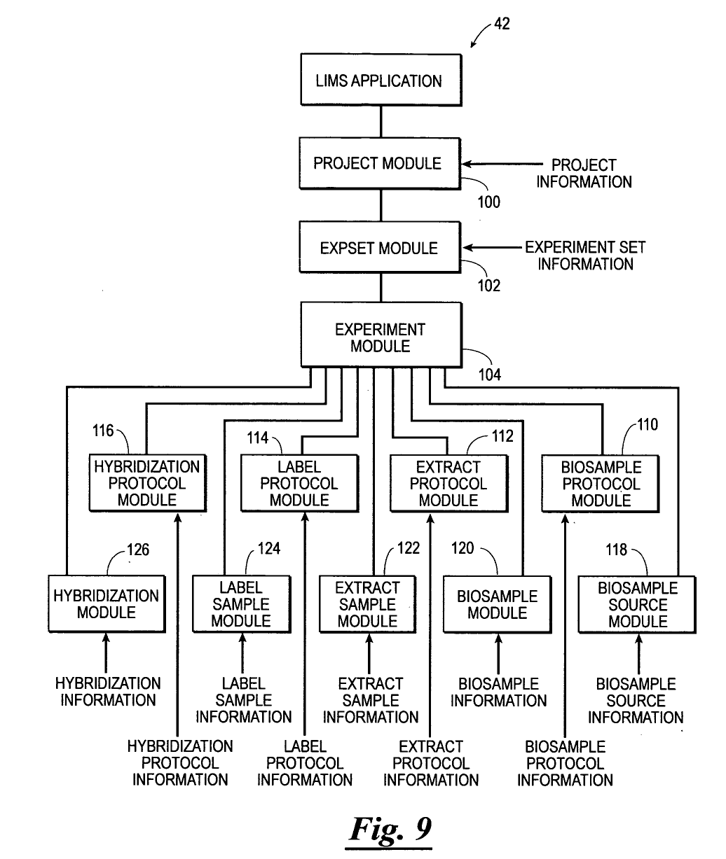

As shown in FIG. 8A, a first step of the Create function is to define a project. In one embodiment, the LIMS application 42 includes a Project module 100 which serves as a top level data container, as shown in FIG. 9. Within the Project module 100, project information is received and stored relating to a project that one or more experiments can be associated with or assigned to. The term “project” generally refers to a collection of one or more related experiments, such as for example experiments directed toward evaluating a single hypothesis or related sub-hypotheses. The project information can include an identifying project name, number or other descriptive identifier, for example. In one embodiment, to create a new project, the project information is inputted into the Project module 100 via an input field in the user interface (not shown). However, it should be understood that any input means can be used to input the project information.

In a next step of the Create function, an experiment set is defined. In one embodiment, the LIMS application 42 includes an ExpSet module 102, which functions as a second level data container. Within the ExpSet module 102, experiment set information is received and stored relating to at least one experiment set of the project that experiments can be associated with or assigned to. The term “experiment set” generally refers to a set of experiments that collectively consists of several measurements corresponding to a series of time points or a series of similar treatments. The experiment set information can include an identifying experiment set name, number or other descriptive identifier, for example. In one embodiment, the experiment set information is inputted into the Expset module 102 via an input field in the user interface (not shown). However, it should be understood that any input means can be used to input the experiment set information.

After the experiment set is defined for the Create function, the user 14 is prompted to input experiment information relating to an experiment associated with the experiment set. The term “experiment” generally refers to a process performed at a single time point or with a single treatment (for example a time point or treatment in which the user 14 may replicate for validation of a result). In general, the experiment information includes details relating to the formation of a labeled extract sample and the hybridization process for the experiment, as discussed further below. Such information is encapsulated in an Experiment module 104, which functions as a third level data container in the LIMS application 42. In other words, within the Experiment module 104, experiment information is received and stored relating to at least one experiment.

In one embodiment, the information encapsulated in the Experiment module 104 of the LIMS application 42 is received and stored in separate modules, which include a “BioSample Protocol” module 110, an “Extract Protocol” module 112, a “Label Protocol” module 114, a “Hybridization Protocol” module 116, a “BioSample Source” module 118, a “BioSample” module 120, an “Extract Sample” module 122, a “Label Sample” module 124, and a “Hybridization” module 126, as shown in FIG. 9.

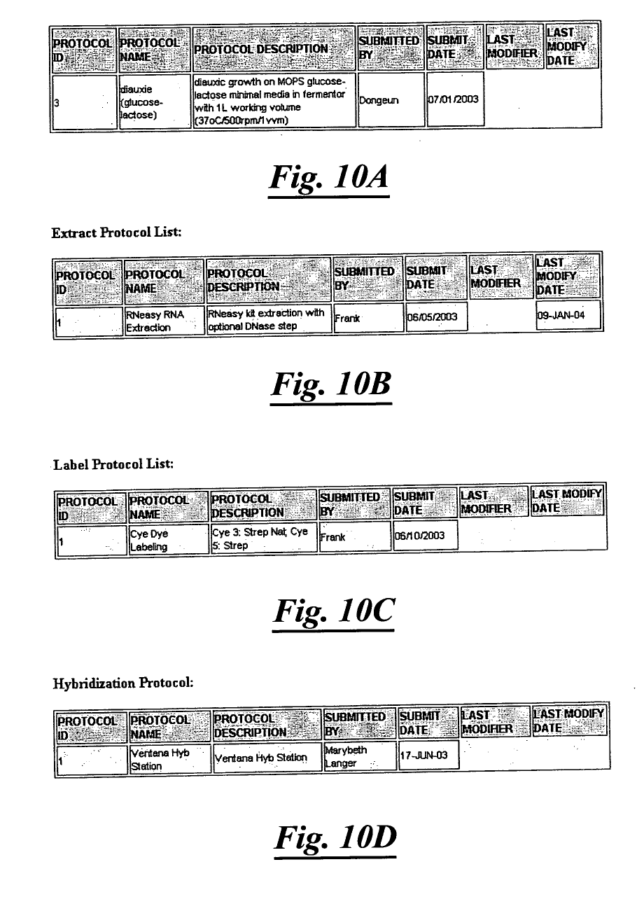

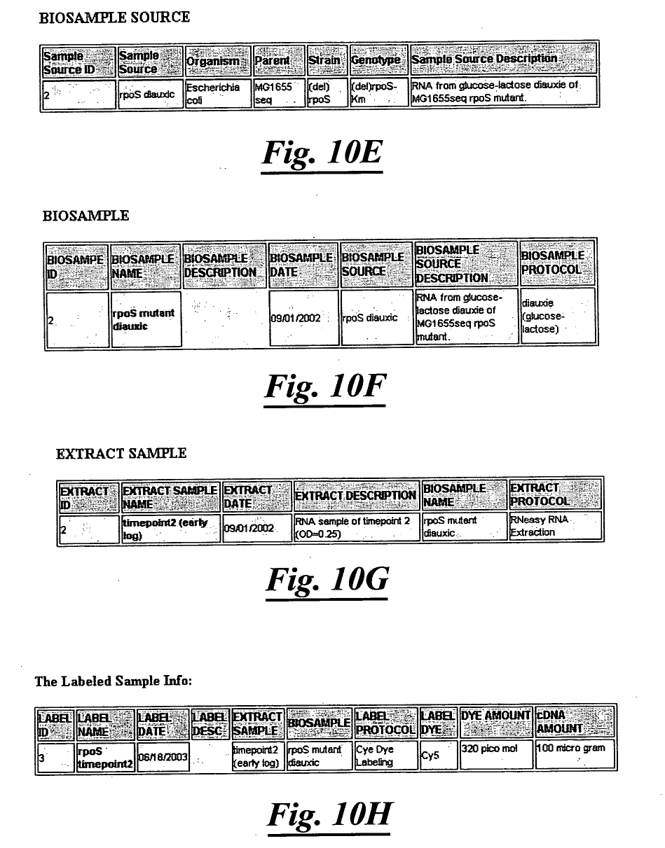

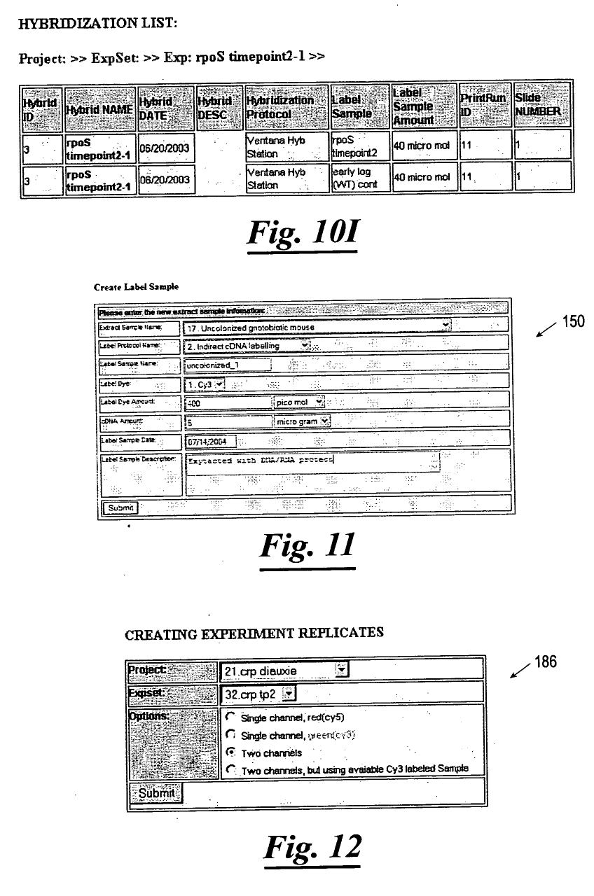

Within the Biosample Protocol module 110, biosample protocol information is received and stored relating to the protocol used to produce a biosample from a biosample source. In general, the biosample protocol information is indicative of how the biosample associated with the experiment was treated during production, such as for example the culture conditions for the biosample. The biosample protocol information can include a name, number or other descriptive identifier for the biosample protocol, a description of the biosample protocol, an identity of a submitter of the biosample protocol, a date the biosample protocol was submitted, an identity of a last modifier, and a date of the last modification, for example. In one embodiment, the biosample protocol information is inputted into the Biosample Protocol Module 110 via a plurality of input fields in the user interface (not shown). Also, the biosample protocol information inputted for the biosample protocol can be displayed to the user 14 via the user interface, as shown for example in FIG. 10A.

Within the Extract Protocol module 112, extract protocol information is received and stored relating to the protocol used to extract a sample. In general, the extract protocol information is indicative of the process by which RNA samples were extracted from the biosample. The extract protocol information can include a name, number or other descriptive identifier for the extract protocol, a description of the extract protocol, an identity of a submitter of the extract protocol, a date the extract protocol was submitted, an identity of a last modifier, and a date of the last modification, for example. In one embodiment, the extract protocol information is inputted into the Extract Protocol module 112 via a plurality of input fields in the user interface (not shown). Also, the extract protocol information inputted for the extract protocol can be displayed to the user 14 via the user interface, as shown for example in FIG. 10B.

Within the Labeled Protocol module 114, label protocol information is received and stored relating to the protocol used to label the biosample associated with the replicate. In general, the label protocol information is indicative of the process by which RNA samples are labeled with dyes, radioisotopes, biotin, etc, so as to provide a labeled extracted biosample. The label protocol information can include a name, number or other descriptive identifier for the label protocol, a description of the label protocol, an identity of a submitter of the label protocol, a date the label protocol was submitted, an identity of a last modifier, and a date of the last modification, for example. In one embodiment, the label protocol information is inputted into the Labeled Protocol module 114 via a plurality of input fields in the user interface (not shown). Also, the label protocol information inputted for the label protocol can be displayed to the user 14 via the user interface, as shown for example in FIG. 10C.

Within the Hybridization Protocol module, hybridization protocol information is received and stored relating to the protocol used for hybridization. In general, the hybridization protocol information is indicative of the process by which labeled samples and microarray spots are hybridized. The hybridization protocol information can include a name, number or other descriptive identifier for the hybridization protocol, a description of the hybridization protocol, an identity of a submitter of the hybridization protocol, a date the hybridization protocol was submitted, an identity of a last modifier, and a date of the last modification, for example. In one embodiment, the hybridization information is inputted into the Hybridization Protocol module 1 16 via a plurality of input fields in the user interface (not shown). Also, the hybridization protocol information inputted for the hybridization protocol can be displayed to the user 14 via the user interface, as shown for example in FIG. 10D.

Within the Biosample Source module 118, biosample source information is received and stored relating to a biosample source. In general, the biosample source information is indicative of an organism, a strain, a genotype, etc. The biosample source information can include a name, number or other descriptive identifier for the biosample source, a description of the biosample source, an identification of an organism associated with the biosample source, an identification of a parent associated with the biosample source, an identification of a strain associated with the biosample source, and an identification of a genotype associated with the biosample source, for example. In one embodiment, the biosample source information is inputted into the Biosample Source module 118 via a plurality of input fields in the user interface (not shown). Also, the biosample source information inputted for the biosample source can be displayed to the user 14 via the user interface, as shown for example in FIG. 10E.

Within the Biosample module 120, biosample information is received and stored relating to a biosample. In general, the biosample information is indicative of a biological laboratory experiment from which an RNA sample is extracted for a biosample source, such as for example for a bacterial culture or tissue culture. The biosample information can include a name, number or other descriptive identifier for the biosample, a description of the biosample source, a date the biosample was produced, an identification of the biosample protocol used to produce the biosample (such as the biosample protocol name), and an identification of the biosample source used to produce the biosample (such as the biosample source name), for example. By including the identification of the biosample protocol and the biosample source, it can be seen that the biosample information in the Biosample module 120 is linked to the biosample protocol information in the Biosample Protocol module 110 for the corresponding biosample protocol and to the biosample source information in the Biosample Source module 118 for the corresponding biosample source, respectively.

In one embodiment, the biosample information is inputted into the Biosample module 120 via a plurality of input fields and/or lists in the user interface (not shown). Also, the biosample information inputted for the biosample can be displayed to the user 14 via the user interface, as shown for example in FIG. 10F.

Within the Extract Sample module 122, extract sample information is received and stored relating to an extracted sample. In general, the extract sample information in indicative of an extracted RNA representing gene expression in a biological experiment. The extract sample information can include a name, number or other descriptive identifier for the extracted sample, a date the extracted sample was extracted, a description of the extracted sample, an identification of the extract protocol used to produce the extracted sample (such as the extract protocol name), and an identification of the biosample used to produce the extracted sample (such as the biosample name), for example. By including the identification of the extract protocol and the biosample, it can be seen that the extract sample information in the Extract Sample module 122 is linked to the extract protocol information in the Extract Protocol module 112 for the corresponding extract protocol and to the biosample information in the Biosample module 120 for the corresponding biosample, respectively.

In one embodiment, the extract sample information is inputted into the Extract Sample module 120 via a plurality of input fields and/or lists in the user interface (not shown). Also, the extract sample information inputted for the extracted sample can be displayed to the user 14 via the user interface, as shown for example in FIG. 10G.

Within the Label Sample module 124, label sample information is received and stored relating to a labeled extracted sample. In general, the label sample information in indicative of a labeled RNA sample used to hybridize to probes. The label sample information can include a name, number or other descriptive identifier for the labeled extracted sample, a date the extracted sample was labeled, a description of the label used, a label dye type, a label dye amount, an amount of cDNA synthesized, an identification of the label protocol used to produce the labeled extracted sample (such as the label protocol name), an identification of the extracted sample used to produce the labeled extracted sample (such as the extracted sample name), and an identification of the biosample used to produce the extracted sample (such as the biosample name), for example. By including the identification of the label protocol, the extracted label and the biosample source, it can be seen that the label information in the Label Sample module 124 is linked to the label protocol information in the Label Protocol module 114 for the corresponding label protocol, to the extract sample information in the Extract Sample module 122 for the corresponding extracted sample, and to the biosample information in the Biosample module 120 for the corresponding biosample, respectively.

In one embodiment, the label sample information is inputted into the Label Sample module 124 via a plurality of input fields and lists in a “Create Label Sample” input means 150 in the user interface, as shown for example in FIG. 11. In the Create Label Sample input means 150, the user 14 inputs the extracted sample name by making a selection in a list of preexisting extracted sample names, e.g., in a list in a pull down menu. The user 14 inputs the label protocol name for the label protocol used to produce the labeled extracted sample by making a selection in a list of preexisting label protocol names, e.g., in a list in a pull down menu. The user 14 inputs the label sample name, date and description in corresponding entry fields. The user 14 inputs the label dye type by making a selection in a list of predetermined label types, e.g., in a list in a pull down menu. The user 14 inputs a label dye amount and a cDNA amount using corresponding entry fields for the quantity and selections in predetermined list for the units, e.g., in lists in a pull down menu. However, it should be understood that any input means can be used to input the label information in the Label Sample Module 124. Further, the label sample information inputted for the labeled extracted biosample can be displayed to the user 14 via the user interface, as shown for example in FIG. 10H.

Within the Hybridization module 126, hybridization information is received and stored relating to a hybridization process (i.e., the process by which base pairs are formed between complementary regions of two strands of DNA). The hybridization information can include a name, number or other descriptive identifier for the hybridization, a date the hybridization was performed, a description of the hybridization, an identification of the hybridization protocol used for the hybridization (such as the hybridization protocol name), an identification of the labeled extracted sample used for the hybridization (such as the labeled extracted sample name), an amount of the labeled extracted sample used for the hybridization, and an identification of at least a portion of a microarray used for the hybridization (such as the print run number identifier and the slide number), for example. By including the identification of the hybridization protocol and the labeled extracted sample, it can be seen that the hybridization information in the Hybridization module 126 is linked to the hybridization protocol information in the Hybridization Protocol module 116 for the corresponding hybridization protocol and the label sample information in the Label Sample module 124 for the corresponding labeled extracted sample, respectively. Additionally, it can be seen that by including the identification of the portion of the microarray used for the hybridization, the hybridization information in the Hybridization module 126 for the hybridization is also linked to the array information in the Array Production Management application 40 (discussed above) for the corresponding microarray, and in particular to the array layout information in the Array Layout module 54 (which is also linked to the Array Production List Module 52, the Plates List Module 56, the individual Plate module 58 and the Gene Annotation module 60).

In one embodiment, the hybridization information is inputted into the Hybridization module 126 via a plurality of input fields and/or lists in the user interface (not shown). Also, the hybridization information inputted for the hybridization process can be displayed to the user 14 via the user interface, as shown for example in FIG. 10I.

It is important to note that the Label Sample module 124 and the Hybridization module 126 of the LIMS application 42 of the present invention allow the user 14 to track information relating to the total amount of a labeled extracted sample produced and use of a certain quantity (e.g., a number of picomoles) of the labeled extracted sample for one or more experiments. Thus, the LIMS application 42 can be utilized as a record keeping system which aids the user 14 (or other users 14) in planning experiments and reviewing an experiment after it is completed. In other words, the LIMS application 42 can function as a type of inventory or quality control means that subtracts the amount used from each labeled extracted sample so as to keep an updated record of an amount of remaining labeled extracted sample. Such a quality control feature can be used to indicate or warn the user 14 (or other users 14) if an impossible or illegitimate experiment has been claimed as being performed when the experiment is indicated as having been performed with materials that were expended in previous experiments. Further, such a feature can be used to provide users 14 with an interactive look-up listing of labeled extracted samples from which information related to various labeled extracted samples can be readily accessed and viewed. This listing can be used for example to plan future work with one or more particular labeled extracted samples.

Once all the information has been inputted into the Create function for the experiment, the LIMS application 42 creates corresponding data locations so that hybridization experiment results (e.g., a data set and image) can be individually uploaded for the experiment, as discussed further below with respect to the Data Import application 44.

As seen from the discussion above the Create function of the LIMS application 42 allows a user to associate an experiment with an experiment set and project of choice. Further, each experiment is linked to information relating to its biosample source, its biosample and biosample protocol, its extracted sample and extract protocol, its labeled extracted biosample and label protocol, and its hybridization and hybridization protocol. When a new experiment is the first to be associated with a new project, the option is offered to create all entities of the modules of the LIMS application 42. However, if a new experiment is a replicate associated with an existing project that includes at least one other existing experiment, information that is expected to be common between the new experiment and the at least one existing experiment can be automatically entered for the new experiment by the server 18 of the MDB system 10. For example, information within the Project Module 100, ExpSet module 102 and Experiment module 104 can be automatically retrieved for a new replicate experiment from at least one corresponding existing experiment once a relationship is indicated between the replicate experiment and the existing experiment. Further, information within the Biosample module 120, Extract Sample module 122, Label Sample module 124 and the Hybridization module 126 can be automatically retrieved for the new replicate experiment from the at least one corresponding existing experiment based on information provided in the Biosample Source module 118, Biosample Protocol module 110, Extract Protocol module 112, Label Protocol module 114 and the Hybridization Protocol module 116 for the replicate experiment since the information within these modules are linked.

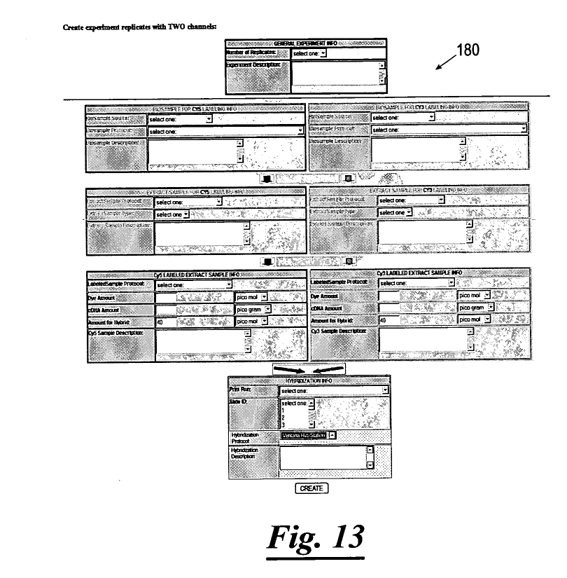

As such, to input information for replicate experiments in the LIMS application 42, the user 14 preferably uses the truncated Create function for replicate experiments shown in FIG. 8B. In one embodiment, once the user 14 indicates that information is to inputted for replicate experiments, the LIMS application 42 provides a “Create Replicates” input means 180 to the user 14 in the user interface, as shown for example in FIG. 12-13.

In a first window of the Create Replicates input means 180, the user 14 is prompted to identify a project and an experiment set with which the replicate experiments are to be associated. Since the replicate experiments are associated with a preexisting project, the project information for the replicate experiments can be automatically determined and provided by the server 18 from the identification of the associated preexisting project. For example, as shown for in FIG. 12, the user 14 can identify the project by making a selection in a list of preexisting project names, e.g., in a list in a pull down menu. However, it should be understood that any input means can be used to input the project information or identify the preexisting project.

Similarly, since the replicate experiments are associated with a preexisting experiment set, the experiment set information for the replicate experiments can be automatically determined and provided by the server 18 from the identification of the associated preexisting experiment set. For example, as shown in FIG. 12, the user can identify the experiment set by making a selection in a list of preexisting experiment set names, e.g., in a list in a pull down menu. However, it should be understood that any input means can be used to input the experiment set information or identify the preexisting experiment set.

In a second window of the Create Replicates input means 180, the user 14 is also prompted to input the number of replicate experiments by selecting from a list of numbers, e.g., in a list in a pull down menu, as shown for example in FIG. 13. Further, the user 14 is also allowed to input an experiment description for the replicate experiments in an entry field, as shown for example in FIG. 13. However, it should be understood that any input means can be used to input the number of replicate experiments or the experiment description.

Preferably, the Create Replicates input means 180 is adapted to allow the user 14 to input information for either or both single channel or two channel labeling, e.g., when a red (cy5) label and/or a green (cy3) label is used. As such, the user 14 can indicate to the LIMS application 42 which label or labels were used so that the LIMS application 42 can format the Create Replicates input means 180 accordingly. In one embodiment, the user 14 is prompted to indicate the labels used in a first window of the Create Replicates input means 180. For example, as shown in FIG. 12, the user 14 indicates the labels used by selecting from a predetermined list of options represented by radio buttons in the user interface, wherein such options are given for a single channel red (cy5) label, a single channel green (cy5) label, two channels with reference to both green (cy3) and red (cy5) labels, and two channels but with reference to only the green (cy3) label. However, it should be understood that any input means can be used to provide the channel information.

For purposes of brevity and illustration, the Create Replicates input means 180 is discussed further below and shown herein in one embodiment with regards to two channels with reference to both green (cy3) and red (cy5) labels. From the discussion of the two channels and two labels, it will be apparent to one of ordinary skill in the art how to format the Create Replicates input means 180 for only one of the channels, either for a green (cy3) label or red (cy5) label, or for two channels but with reference to only the green (cy3) label, as unnecessary entries for inputting, storing, and/or displaying information can be omitted, ignored or otherwise not utilized.

Once the Create Replicates input means 180 is formatted accordingly for the channels and number of replicate experiments, the user 14 is prompted in the second window of the Create Replicates input means 180 to identify the biosample source, the biosample protocol, the extract sample protocol, the label protocol, and the hybridization protocol for the red (cy5) label and the green (cy3) label for the experiment replicates. From such information, the server 18 can automatically determine and provide at least a portion of the experiment information for the replicate experiments since the replicate experiments will have at least some experiment information in common with at least one other preexisting experiment.

For example, as shown in FIG. 13, the user 14 can identify a preexisting biosample source, biosample protocol, extract sample protocol, label protocol, and hybridization protocol by making a selection from a list of preexisting biosample source names, biosample protocol names, extract sample protocol names, label protocol names, and hybridization protocol names, respectively, such as lists in pull-down menus in the user interface for the red (cy5) label and the green (cy3) label. However, it should be understood that any input means can be used to identify the preexisting biosample source, biosample protocol, extract sample protocol, label protocol, and hybridization protocol.

Also, the user 14 is prompted in the second window of the Create Replicates input means 180 to input at least a portion of the label information for the red (cy5) label and the green (cy3) label, as shown for example in FIG. 13. In one embodiment, the user 14 inputs a label dye amount, a cDNA amount, an amount of the labeled extracted sample used for hybridization, and a description of the label for the red (cy5) label and the green (cy3) label. For example, as shown in FIG. 13, the description and the quantity for the amounts can be inputted in entry fields, and the units for the amounts can be inputted by making a selection in a list of preexisting units, e.g., in a list in a pull-down menu. However, it should be understood that any input means can be used to input the label information.

Further, the user 14 is prompted in the second window of the Create Replicates input means 180 to input at least a portion of the hybridization information for the set of replicate experiments, as shown for example in FIG. 13. In one embodiment, the user 14 inputs a description of the hybridization and an identification of at least a portion of the microarray used for the hybridization, such as for example the print run file name and the slide number identifier for the microarray. For example, as shown in FIG. 13, the user 14 can input the description of the hybridization in an entry field. The user 14 can input the print run file name by making a selection in a list of preexisting print run file names, e.g., in a list in a pull-down menu, and can input the slide number identifier by making a selection in a list of preexisting slide number identifiers, e.g., in a list in a scroll menu. However, it should be understood that any input means can be used to input the hybridization information.

Once all the information has been inputted into the Create function for the replicate experiments, the LIMS application 42 creates corresponding data locations so that experiment results (e.g., data sets and images) can be individually uploaded for each replicate experiment since each will have its own hybridization results to upload when the entire experiment is complete.

From the above discussion, it can be seen that the Create function for replicate experiments of the LIMS application 42 saves time because repetitive tasks are done only once. Further, the flow of the Create function reflects the way a user 14, such as a biologist or scientist, would intuitively think about the experiment. Although a collective experiment is performed as a set of replicate experiments, the results for each replicate experiment are unique and should be individually maintained. Also, the experiment results are generally handled as unique during data analysis, although they may be averaged at some later point in the analysis.

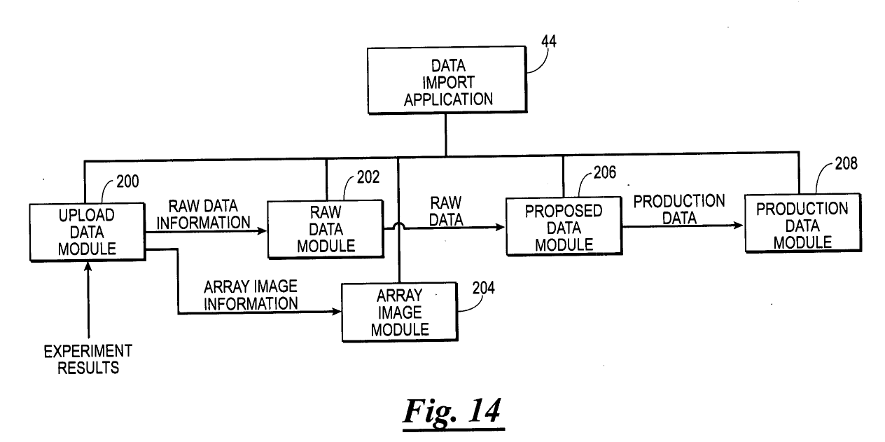

As mentioned above, the Data Import application 44 of the present invention is, in general, used to import and process experiment results for hybridized microarrays. More particularly, the Data Import application 44 is used for recording, storing and processing experiment results, including information relating to the raw data and digitized images collected for experiments. In one embodiment, the Data Import application 44 includes an “Upload Data” module 200, a “Raw Data” module 202, an “Array Image” module 204, a “Preprocessed Data” module 206 and a “Production Data” module 208, as shown in FIG. 14.

Within the Upload Data module 200, raw data information and array image information is retrieved or uploaded for the experiment. Generally, each technology platform currently in use (such as for example membranes, microarrays, and Affymetrix GeneChips) has a specific raw data format and image format associated with it. For example, raw data and an image can be generated using a scanner platform-specific image processing software such as GenePix. The Upload Data module 200 brings the raw data information from a specific platform into the Raw Data module 202 where it is staged for preprocessing, and brings the array image information into the Array Image module 204.

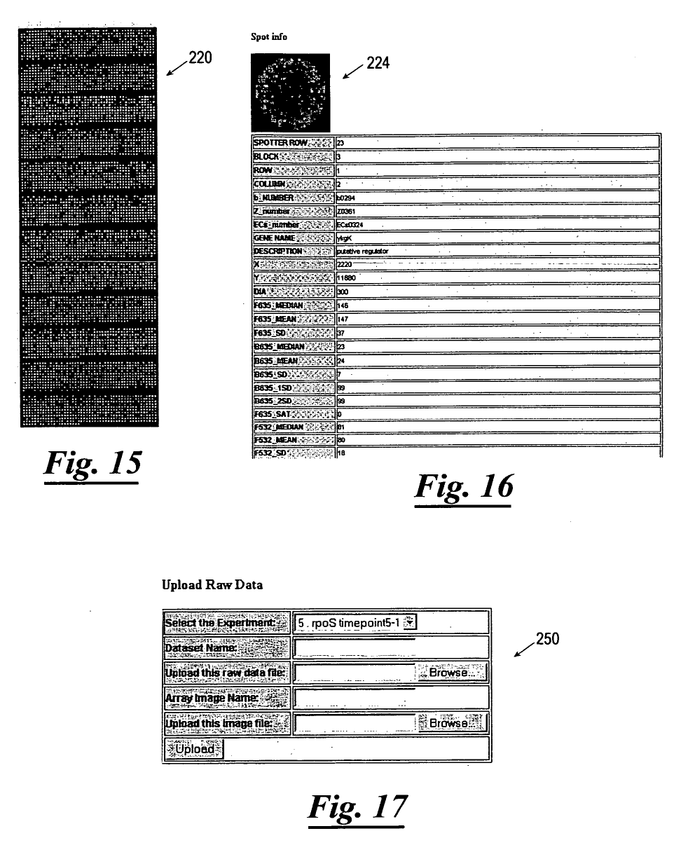

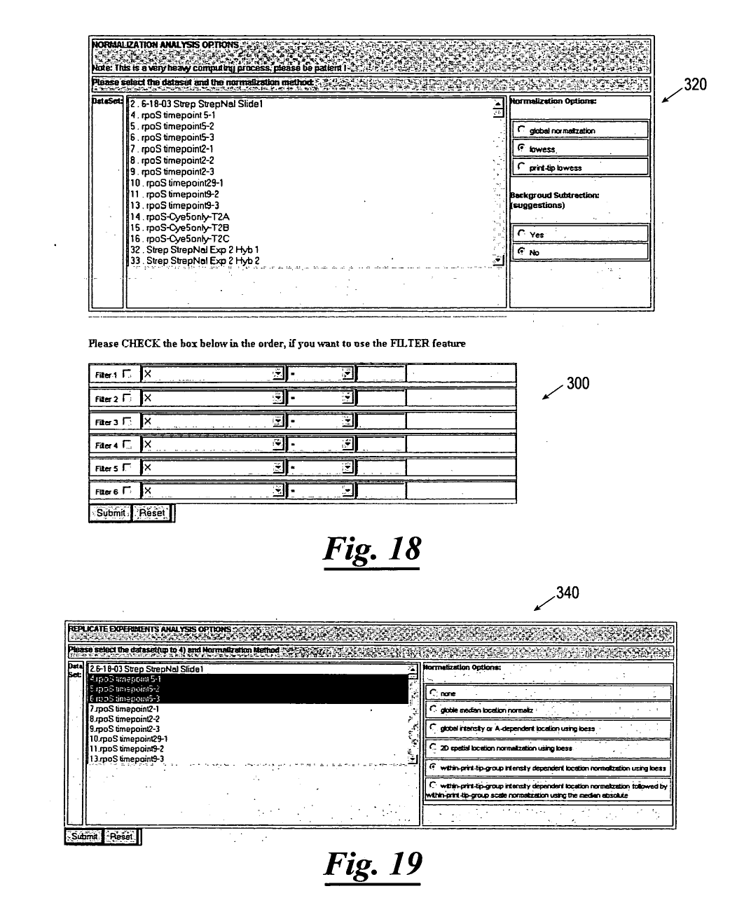

In one embodiment, a raw data file containing the raw data information and an associated array image file containing the array image information are uploaded via the Upload Data module 200 to the Raw Data module 202 and the Array Image module 204, respectively. In general, the raw data file includes intensity data, generally in a spreadsheet format. For example, the raw data file can be an “Excel” file. The array image file generally includes graphical data for the hybridized spots of a microarray from which an image 220 of the microarray (as shown for example in FIG. 15), and/or an image 224 of one or more individual spots of the microarray (as shown for example in FIG. 16), can be generated and displayed to the user 14 via the user interface. For example, the array image file can be a “jpeg” or “tiff” file.

The raw data information and array image information can be for example uploaded from a device outputting such data (such as a scanner), from a file stored on a storage media (such as a hard disk drive, a compact disk, floppy disk, etc.), or from a computer database (such as a database of the user system 22 or other remote computer). Further, image processing information such as scan power and laser power can also be uploaded.

In one embodiment, so that raw data files and array image files can be easily uploaded by user 14 via the user system 22, the user 14 is provided with an upload means 250 in the user interface, as shown for example in FIG. 17. The upload means 250 allows the user 14 to identify the experiment for which the raw data file and the array image file are being uploaded. From the identification of the associated experiment, the server 18 can link the information in the LIMS application 42 to the experiment results in the Data Import Application 44. This provides that the higher level information is only entered once and does not need to be added every time experiment results for replicate experiments are uploaded.

For example, as shown in FIG. 17, the user 14 can identify the associated experiment by selecting the experiment name in a list of preexisting experiment names, e.g., in a list in a pull down menu. However, it should be understood that any input means can be used to identify the associated experiment.

In the upload means 250, the user 14 also indicates the location from which the raw data file and the array image file can be uploaded. For example, as shown in FIG. 17, the user 14 inputs a file or URL name (including directory headings) for the raw data file and the array image file in corresponding entry fields (e.g., by using a “browse” feature). Also, in the upload means 250, the user can assign a dataset name for the set of raw data in the raw data file, and an array image name for the image in the array image file. For example, as shown in FIG. 17, the user 14 can input the dataset name and array image name in corresponding entry fields in the upload means 250. However, it should be understood that any input means can be used to input the file locations and the dataset and array image names.

In one embodiment, the server 18 of the present invention links or associates the raw data information and the array image information in the Data Import application 44 with the experimental information in the LIMS application 42 such that the graphical information for the microarray, and further for each spot in the microarray, is linked to its intensity data and LIMS information. Further, the uploaded array image is preferably linked to the spotting run from which it was created, i.e., the array information in the Array Production Management application 40. As such, the MDB system 10 allows for the linking of array production information, LIMS information, and experimental information. Such linking gives users 14 the ability to relate information describing array production (e.g., how a microarray was spotted and with what materials) to each experiment done with a microarray, including all the experiment parameters, hybridization results, and analysis results.

For example, if a spot does not seem to perform as desired in an experiment, a user (e.g, a scientist or lab manager) can visualize graphics of the hybridized spot and intensity numbers for as many experiments as desired. Also, each experiment can be linked to a day the array was produced and materials used. This is a separate issue from the day experiments were conducted using the microarrays. However, during problem solving, a user generally must consider both microarray production and microarray experimental procedures using completed microarrays. The MDB system 10 of the present invention facilitates this problem solving process by linking details of array production and details of array experiments. As such, the MDB system 10 provides the user 14 with information to decide whether a spot's problems are caused by spotting methods and materials, or by experimental methods and materials.

Further, each portion of the array image which is indicative of one of the spots in the spotting run is linked to the raw data and LIMS information associated with the corresponding spot, and thus provides qualitative information for each spot. For example, shown in FIG. 16 (along with the spot image 224 showing an exemplary spot) is a portion of the corresponding information linked for that spot, which is displayed to the user 14 in the user interface. The linking of various information on the individual spot level allows pieces of data to be recalled without necessarily being provided as part of a data set or table. For example, all information on one individual spot can be recalled from multiple experiments without having to recall data for entire experiments, which would also contain data for neighboring spots. In other words, each piece of data for each spot on one more microarrays can be retrieved individually in the MDB system 10 of the present invention.

As discussed above, uploading the raw data information and the array image information using the Upload Data module 200 places the raw data file data into the Raw Data module 202, which serves as staging area for raw data storage for integration into the Preprocessed Data module 206 (and subsequently the Production Data module 208). Within the Preprocessed Data module 206, the raw data from the Raw Data module 202 for one or more experiment is transformed according to a platform-specific protocol by normalization, filtering, scaling, etc., in a pre-processing step, and is converted into a common format employed for the Production Data module 208 by averaging experiments and calculating statistical metrics so as to generate preprocessed data. For example, for membrane arrays, generally phosphor imaging is used to produce a TIFF image file that is further processed in ArrayVision™ ver 5.1, Imaging Research, Inc. software. The resulting raw data is preferably normalized by a global normalization strategy and replicate experiments are chosen for calculation of expression averages, ratios, and statistical confidence. As another example, Affymetrix GeneChip arrays are generally scanned on a platform specific system and the image is processed by using a platform-specific software package. The resulting raw data is preferably normalized and scaled, then replicate experiments are chosen for calculation of on/off threshold, expression averages, ratios, and statistical confidence.

In one embodiment, the Preprocessed Data module 206 includes a plurality of processing tools which the user 14 can use via the user interface. In general, such processing tools allow the user to arrange, mathematically manipulate, or otherwise process data. More particularly, the processing tools relate to pre-filtering, normalization, statistical analysis, experimental replicate comparison and/or replicate averaging, for example. By integrating processing tools into the user interface, the user 14 can be prompted in how to apply procedures, such as for example state-of-the-art procedures for pre-filtering spot information, whole microarray and microarray-microarray normalization, statistical significance of results, and comparison and averaging of replicate experiments.

Further, the processing tools allow the Preprocessed Data module 206 to be adapted for quality control of raw data by the user 14 so that the raw data can be evaluated before being sent to the Production Data module 208 as preprocessed data. In one embodiment, the user 14 can review one or more individual spot images and the information related to the spot images to ascertain whether raw data is reliable or of a suitable quality and decide whether or not to enter them into Production Data module 208. For example, the user can evaluate whether the spots behaved properly in the biological experiment and whether at any time the results for a particular probe may be called into question. Further, the Preprocessed Data module 206 is preferably adapted to allow the user 14 to go back and forth between the image, the raw data file, and probe-specific information for the experiment. This feature of the Preprocessed Data module 208 can also be made accessible from any stage of the operation for the user's reference.

The processing tools of the Preprocessed Data Module 206 in one embodiment are powered by “R” and “Bioconductor” techniques. R is a widely used open source, high-level language and environment for statistical computing and graphics. Bioconductor provides tools for the analysis and comprehension of microarray data (bioinformatics).

In one embodiment, one processing tool is a “Pre-filtering data” analysis tool, which allows the user 14 to flag or remove data points from consideration on the basis of several parameters, including null spots in the array, spot quality (bad spots flagged during scanning or by spot-data analysis), signal to noise ratio, and background subtraction for gene on/off calls. Pre-filtering can also be used for multi-species microarrays to consider only those microarray probes that are specific for genes represented in the biosample source and biosample. In one embodiment, the user 14 is provided with a “Filter Feature” input means 300 in the user interface, as shown for example in FIG. 18. The Filter Feature input means 300 allows the user 14 to indicate a number of filters and a set of parameters for each filter the user 14 wants used on the raw data. As shown in FIG. 18, in one embodiment, the user 14 indicates the number of filters by selecting one or more filter numbers in the form of check boxes. The user 14 indicates the parameters for a filter by selecting from lists in pull-down menus (such as for attributes of the raw data file) and inputting information into an entry field. However, it should be understood that the user 14 can define filters by any input means.

Another processing tool is a “Normalization” analysis tool. In one embodiment, the Normalization analysis tool allows the user 14 to perform at least one of 1) within-print-tip-group intensity dependent location normalization (Lowess) followed by within-print-tip-group scale normalization using the median absolute deviation (scale print-tip), with or without background subtraction, 2) global median location normalization, 3) global intensity or A-dependent location normalization using loess (global loess), 4) 2D spatial location normalization using loess (2D) within-print-tip-group intensity dependent location normalization using loess (print-tip), or 5) total intensity normalization.

In one embodiment, the user 14 is provided with a “Normalization Analysis Options” input means 320 in the user interface, as also shown for example in FIG. 18. The Normalization Analysis Options input means 320 allows the user 14 to indicate the data set or sets the user 14 wants normalized, and the normalization process the user 14 wants used. The user 14 can also indicate whether the user 14 wants background subtraction used. For example, as shown in FIG. 18, the user 14 indicates the one or more data sets by selecting data set names in a list of existing data set names, e.g, in a list in a scrollable menu. The user 14 indicates the normalization process by making a selection in a list of predetermined normalization processes, e.g., in a list in the form of radio buttons. The user 14 indicates whether background subtraction is to be used by selecting from a yes option and no option, e.g., options in the form of radio buttons. However, it should be understood that the user 14 can indicate the one or more data sets, normalization process and background subtraction by any input means.

In another embodiment, the user 14 is provided with a pre-filtering data analysis tool and “Normalization Method” input means 340 in the user interface, as shown for example in FIG. 19, wherein the user 14 can indicate the data set or sets the user 14 wants normalized and the normalization process the user 14 wants used. For example, as shown in FIG. 19, the user 14 indicates one or more data sets for normalization by selecting data set names from a list of existing data set names, e.g., in a list in a scrollable menu. The user 14 indicates the normalization process by making a selection in a list of predetermined normalization processes, e.g., in a list in the form of radio buttons. However, it should be understood that the user 14 can indicate the data sets and normalization process by any input means.

Further, another one of the processing tools can offer the user 14 statistical methods for evaluating experimental noise and for determining whether or not genes are “responders” in experiments. That is, genes with significant, differential expression between experimental conditions in pairwise comparisons. An example statistical method is a simple noise determination, wherein the standard deviation of replicate spots for multiple replicate arrays is determined so as to provide the user 14 with a measure of noise for particular spots (genes) in their replicate experiments.

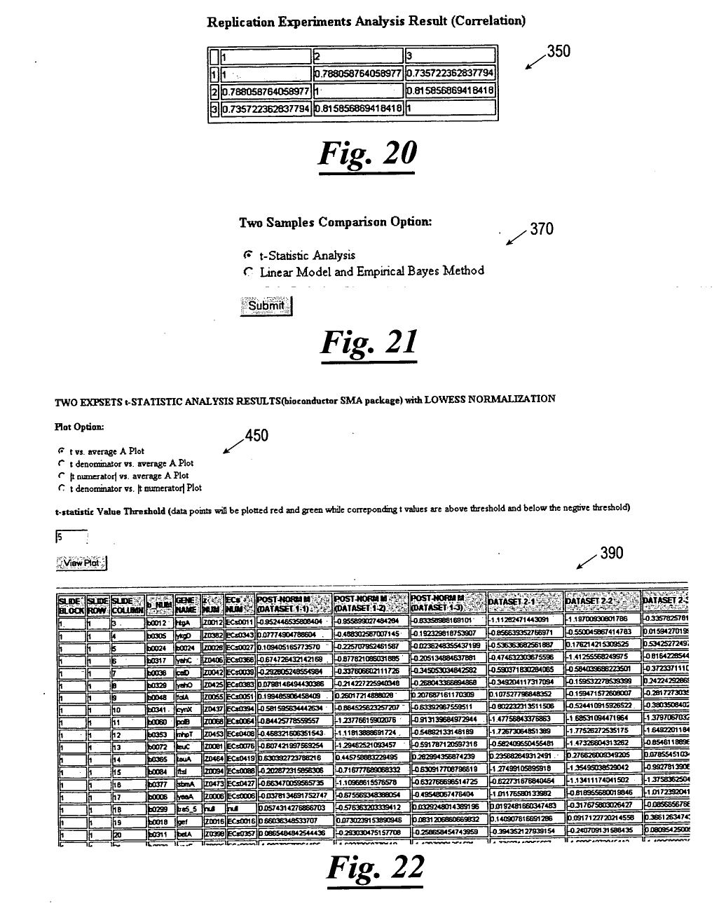

Also, one of the processing tools can allow the user 14 to perform a replicates correlation analysis to evaluate the quality of replicate experiments by determining the simple correlation between replicate experiment results. For example, based on the input provided in the Normalization Method input means 340 (see FIG. 19), the Preprocessed Data module 206 can determine and provide a “Correlation” table 350 to the user 14 in the user interface, as shown for example in FIG. 20, so as to provide correlation information to the user 14.

Further, one of the processing tools can allow the user 14 to perform differential gene expression analysis for two or more experiments. In such an analysis, the user 14 can also be offered choices of methods for evaluating whether individual genes are statistically significant responders in their experiments. In one embodiment, the user 14 is provided with a “Two Samples Comparison Option” input means 370 in the user interface, as shown for example in FIG. 21, which allows the user 14 to indicate whether the user wants to perform a t-statistic analysis or linear model and Empirical Bayes method analysis by making a selection in a list, e.g., in a list in the form of radio buttons. However, it should be understood that the user 14 can indicate a method to be used for differential gene expression analysis by any input means.

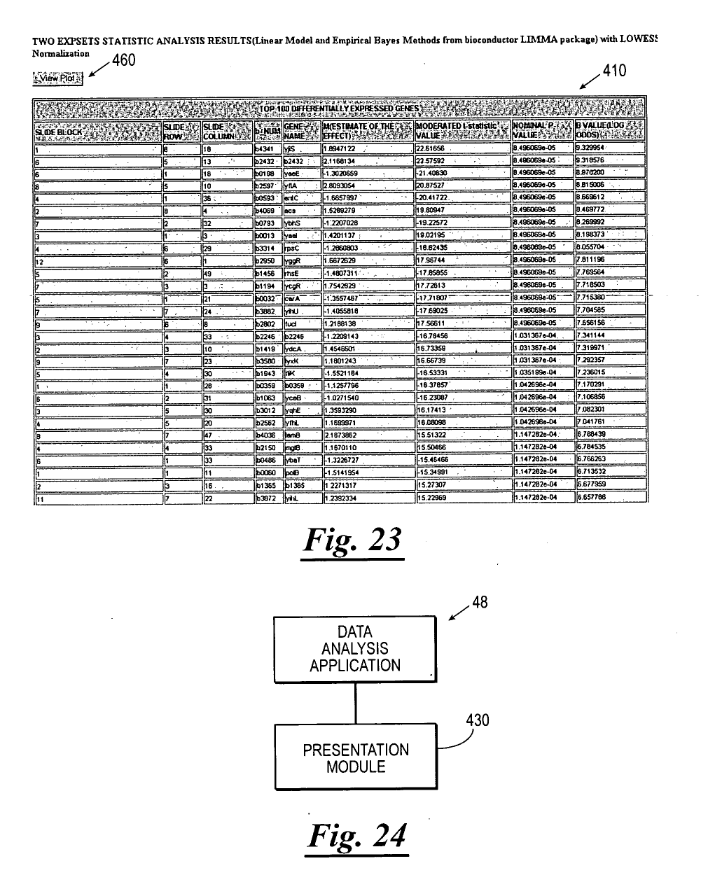

If the t-statistic analysis is indicated in the Two Samples Comparison Option input means 370, then the user 14 is provided with a “t-Statistic Analysis Results” table 390 in the user interface, as shown for example in FIG. 22. If the linear model and Empirical Bayes method is indicated in the Two Samples Comparison Option input means 370, then the user 14 is provided with a “Linear Model and Empirical Bayes Analysis Results” table 410 in the user interface, as shown for example in FIG. 23.

As yet another example, one of the processing tools can allow for data mining, wherein conventional and advanced data mining algorithms (e.g., SVM, MATOM, SOM) can be implemented by the user 14, such as for example for time series analysis and standard cluster analysis.

Within the Production Data module 208, the preprocessed data from the Preprocessed Module 206 is received and stored. In one embodiment, the Production Data module 208 includes a production data table designed to accommodate the most commonly accessed data fields, such as for example microarray intensity, ratio values, and confidence intervals (regardless of the technology platform used). As such, the Production Data module 208 can be adapted to handle for example proteome and metabolome data (provided that Preprocessed Data 206, Raw Data 202 and Upload Data 202 modules are programmed to interface with the specific application).

The purpose for the Production Data module 208 is mainly two-fold. First, the preprocessed data are stored in a format that is standardized for commonly used analytical tools. Second, accessing the preprocessed data from the scaled-down Production Data module 208 with its reduced data fields makes the application of analytical tools operate much faster. For example, such features offer significant advantages (such as for example for displaying transcriptome data) since to Applicants' knowledge, current microarray database systems generally do not truly integrate data generated on different platforms and are notoriously slow in display time because they access data from very large raw data tables.

As such, it can be seen that the Upload Data module 200, the Raw Data module 202, the Preprocessed module 206 and the Production Data module 208 cooperate to form a “pipeline” for experiment results. The pipeline not only allows novice users to preprocess the experiment results for entry into the Production Data module 208 using standardized filtering and normalization protocols, but also sophisticated users can quickly enter experiment results for a large number of experiments.

As mentioned above, the Data Analysis application 48 of the present invention is, in general, used to generate graphical presentations of experiment and analysis results. More particularly, the Data Analysis application 48 provides visual tools, such as for analysis and graphical presentations, which the user 14 can utilized to visualize and evaluate experiment results and analysis results via the user interface. In one embodiment, the visual tools are powered by Netpbm, which transforms post script files to image files.

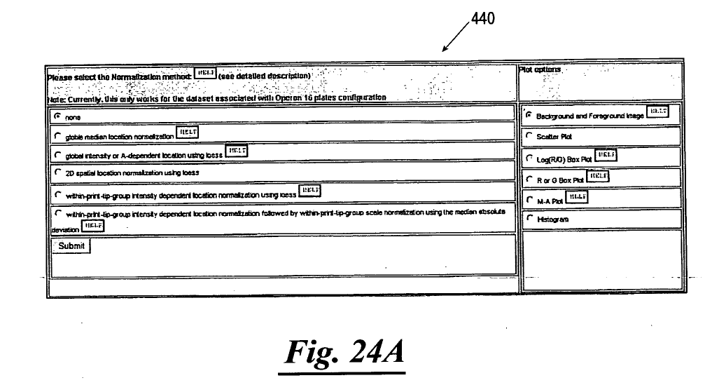

The Data Analysis application 48 includes a “Presentation” module 430, as shown in FIG. 24. In general, the Presentation module 430 contains the visual tools, such as for example tools for generating plots, cluster analysis, graphic displays, heat maps, etc. For example, the Presentation module 430 can be adapted to allow the user 14 to display data using at least one diagnostic plot. Diagnostic plots offer the user 14 a means for evaluating the quality of individual array experiments. Such diagnostic plots can include for example a background and foreground image, a scatter plot, a boxplot histogram (such as a log(R/G) box plot or a R or G box plot), a Cy3-Cy5 plot, and/or a log (Cy3)-log (Cy5) plot.

The Presentation module 430 can also allow the user 14 to display data using a M-A plot. M-A plots are a standard for presenting microarray data from individual or replicate experiments. The M-A plot is preferably offered by the Presentation module 430 for raw data and for data sets which have been filtered and/or normalized, and/or replicated. Further, a M-A plot in the Presentation Module 430 can be adapted so as to allow for annotation and metalink information for individual genes.

In one embodiment, the user 14 is provided with a “Plot Options” input means 440 in the user interface, as shown for example in FIG. 24-A. The Plot Options input means 440 allows the user 14 to indicate the type of plots the user 14 wants to generate and view. Further, the Plot Options input means 440 can also allow the user 14 to indicate an optional normalization method. For example, as shown in FIG. 24A, the user 14 indicates the desired plot type by making a selection in a predetermined list of plot types, e.g., in a list in the form of radio buttons. However, it should be understood that the user 14 can indicate the plot type by any input means.

Further, the Presentation module 430 can allow the user 14 to display a plot of the results of a t-statistic analysis and/or a linear model and empirical Bayes method analysis. In one embodiment, if the t-statistic analysis is indicated in the Two Sample Comparison Option input means 370 (as discussed above), then the user 14 is provided with a “t-statistic” plot means 450 in the user interface, as shown for example in FIG. 22. In the t-statistic plot means, the user indicates the plot options and the value threshold the user 14 wants used to plot t-statistic analysis result. For example, as shown in FIG. 22, the user 14 indicates the desired plot option by making a selection in a predetermined list, e.g., in a list in the form of radio buttons. Further, the user 14 can indicate the value threshold in an entry field. However, it should be understood that the user 14 can indicate the plot option and value threshold by any input means. Once the plot option and value threshold are provided, the plot for the t-statistic analysis results (not shown) is generated and can be displayed to the user 14 via the user interface.

If the linear model and empirical Bayes method analysis is indicated in the Two Sample Comparison Option input means 370, then the user 14 is provided with a Linear Model and Empirical Bayes plot means 460 in the user interface, as shown for example in FIG. 23. For example, as shown in FIG. 23, the user 14 can cause a plot to be generated and displayed to the user 14 via the user interface by using the Linear Model and Empirical Bayes plot means 460, which can be for example in the form of a push button. However, it should be understood that the user 14 can cause the plotting of the linear model and empirical Bayes method analysis results by any input means.

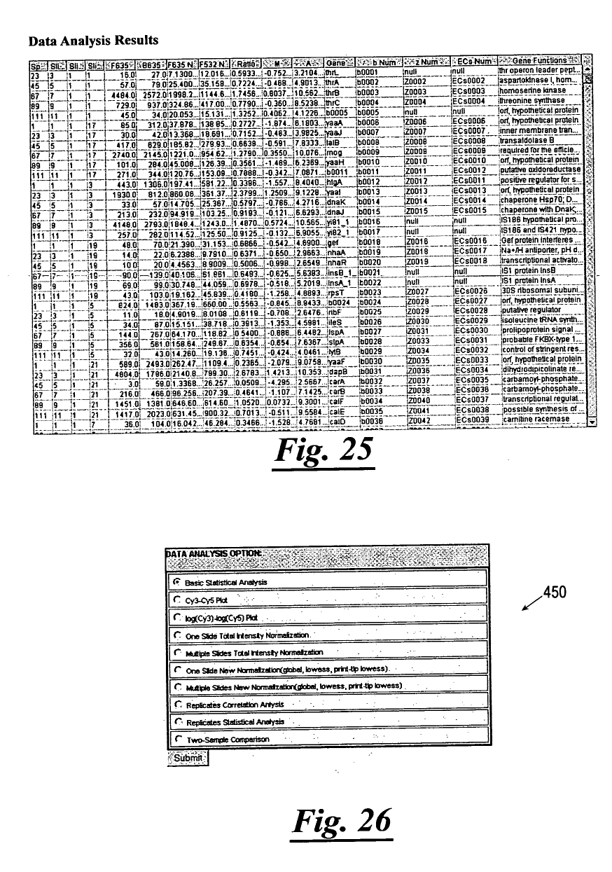

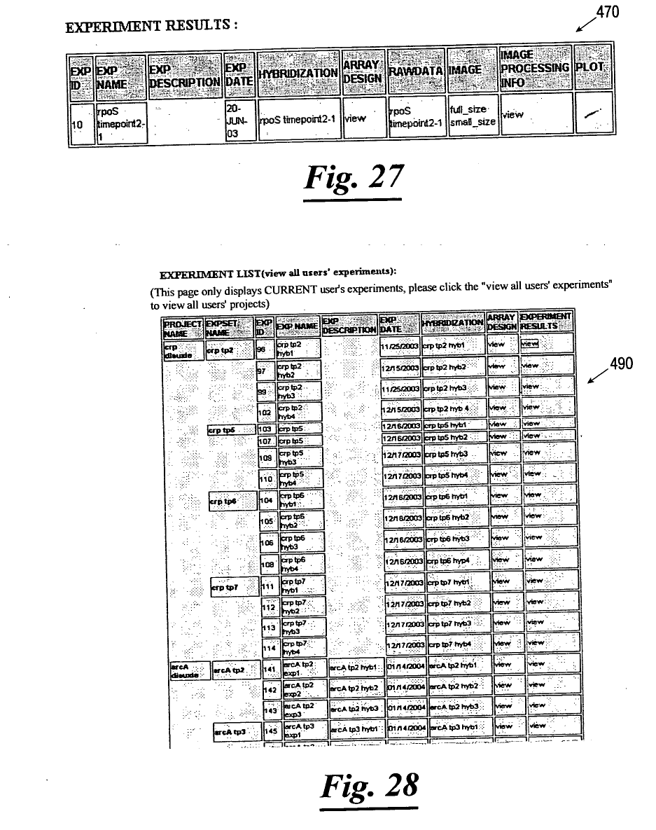

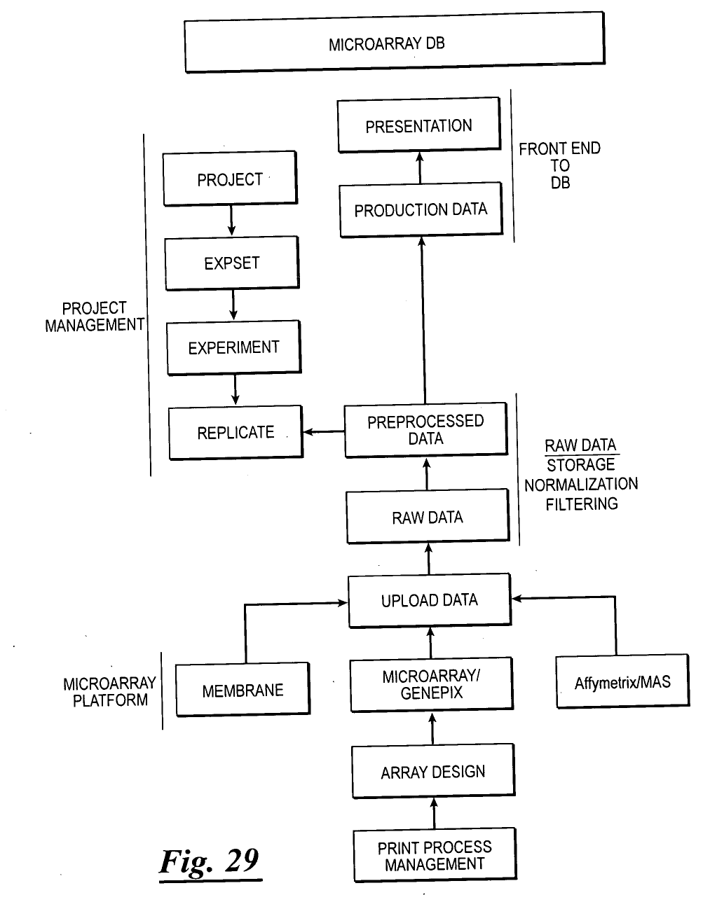

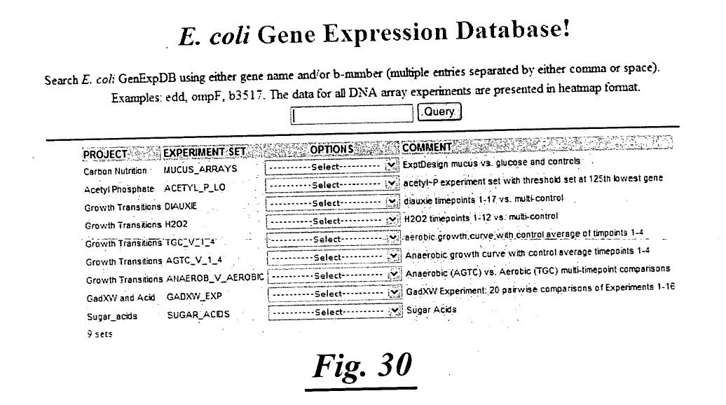

The Presentation module 430 can further include other visual tools. For example, the Presentation module 430 can include a visual tool which allows the user 14 to display and sort data for at least a portion of the experiment information, the experiment results and/or the analysis results, such as for example in a spreadsheet in a JAVA Applet. The Presentation module 430 can allow the user 14 to sort by any criteria, such as for example by the b number. For example, shown in FIG. 25 is an exemplary analysis result, sorted by the b number.

In one embodiment, at least a portion of the processing tools and visual tools of the present invention are made readily available to the user 14 in a “Data Analysis Option” input means 450 in the user interface, as shown for example in FIG. 26. In one embodiment, the Data Analysis Option input means 450 includes tools which allow the user to perform a basic statistical analysis, a Cy3-Cy5 plot, a log(Cy3)-log(Cy5) plot, a one slide total intensity normalization, a multiple slides total intensity normalization, a one slide new normalization (e.g., global, lowess, print-tip lowess), a multiple slide new normalization, a replicate experiments correlation analysis, a replicate experiments statistical analysis, and a two-sample comparison (as discussed above). However, it should be understood that any tools can be included in the Data Analysis Option input means 450.

The Data Analysis Option input means 450 allows the user 14 to indicate one or more processing tools and/or visual tools the user 14 wants to use. For example, as shown in FIG. 26, the user 14 indicates the desired tools by making a selection in a predetermined list, e.g., in a list in the form of radio buttons. However, it should be understood that the user 14 can indicate which tools the user 14 wants to use by any input means.

As mentioned above, the Data Export application 50 of the present invention is, in general, used to export information, such as for example experiment results or analysis results. More particularly, the Data Export application 50 is used for exporting or downloading raw data, analysis data, images, charts, plots, graphs, etc., generated using any other application of the MDB system 10, preferably in a MIAME or GEO compliant form. For example, such information can be exported in a “soft copy” form, such as in a digital file, or in a “hard copy” form, such as in a paper print out. In one embodiment, analysis results are downloaded in a tab delimited text file format so that it can be easily imported to other data analysis software such as Spotfire. For example, the analysis results can be exported to Spotfire, wherein a M-A plot with spots colored by gene function groups contained in the downloaded file are visualized in Spotfire. Also, data interpretation by users (e.g., scientists and researchers) often requires connections (e.g., meta-links) to external databases that handle other pertinent data types. Therefore, unification links to external databases can further be provided for the user 14.

It can be seen that the Data Import application 44, the Data Analysis application 48 and Data Export application 50 of the present invention provide the user 14 with flexibility and speed in the number of combinations and selections that the user 14 can use to analyze data, create tables and plots, and export information. For example, there are ten selections in the Data Analysis Option input means 450 shown in FIG. 26. Once one of these is chosen, there are three normalizations to choose, plus optional background subtraction. Additionally, the data can be filtered to ignore certain spots which are of no concern to the analysis. After selecting from each of these categories, an analysis data file (e.g, a file containing a data table) is created, which can then be downloaded (e.g., as an Excel sheet). Such flexibility and speed offered by the combinatorial aspects of the present invention, along with the ease of generating a file for download, allows the user 14 to create files of different sets of analysis data using a number of analytical and format combinations. Scores of these files could be generated in a day and used directly or copied into another third party program, offering further flexibility in the analysis processes which are usable by the user 14.

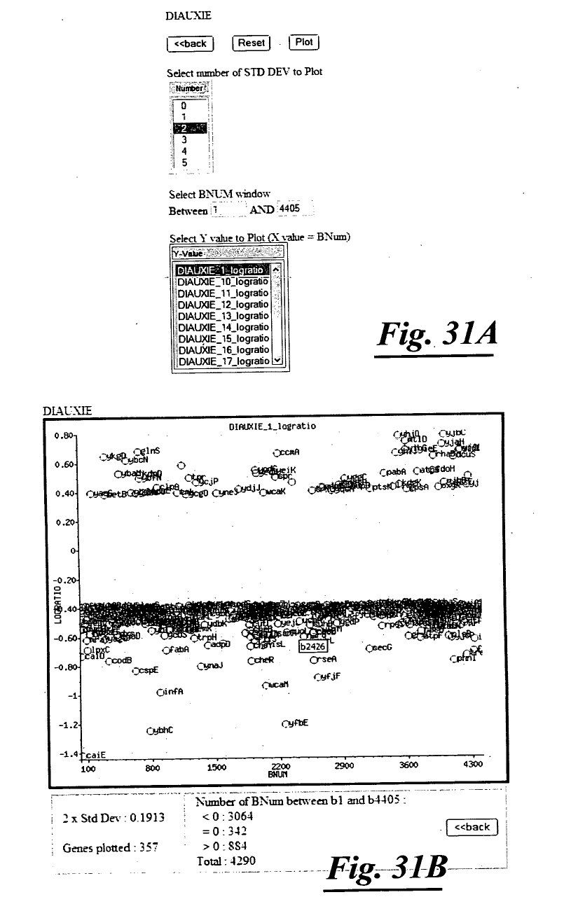

To further manage and provide access to information for the experiment, the server 18 can also display an “Experiment Results” access means 470 to the user 14 in the user interface, as shown for example in FIG. 27. The Experiment Results access means 470 provides the user 14 with a summary of the experiment and links to other information for the experiment in the MDB system 10. For example, as shown in FIG. 27, the Experiment Results access means 470 can include the numerical identifier, name, description, date, and hybridization associated with the experiment. Also, the Experiment Results access means 470 can provide a link to the array design, the raw data, the array image, the image processing information, and the plots associated with the experiment. However, it should be understood that any information, such as for example any portion of the array information, experiment information, experiment results, and/or analysis results, can be made accessible to the user 14 via the Experiment Results access means 470.

Further, the server 18 can display at least a portion of the Experiment Results access means 470 for a plurality of experiments in an “Experiment List” table 490 to the user 14 in the user interface, as shown for example in FIG. 28. In general, the Experiment List table 490 includes information relating to at least one user's experiments which are currently being conducted, and/or which were conducted in the past. However, the Experiment List table 490 can be adapted to include multiple users' experiments, and also to include future planned experiments. As such, the Experiment List table 490 allows users 14 to more readily identify and access experiments currently being conducted, experiment that have been conducted in the past, and or experiments to be conducted in the future.

In one embodiment, the server 18 of the MDB system 10 further includes a “User Management” application 500. In general, the User Management application 500 of the present invention is used to store and manage information associated with one or more users 14 of the MDB system 10, such as those associated within a particular laboratory or research group. For example, information identifying one of the users, such as a user name and/or password, can be defined in the User Management application 500. Further, the User Management application 500 preferably allows for users 14 to be assigned to different categories or levels, wherein each level has associated with it different user rights or privileges within the applications of server 18. In one embodiment, the user levels in the User Management application include an “Administrator” level and a “User” level.

In one embodiment, the User Management application 500 provides an input means (not shown) in the user interface, which allows a user 14 at the administrator level to create or define new user accounts and assign privileges to users 14 at the User level. Preferably, only one user 14 is assigned the role of administrator, and the User level is associated with general users 14 of the MDB system 10. Within the User level, different users 14 can be given different privileges. Further, the User Management application 500 can provide an input means (not shown) which allows the users 14 at the User level to individually change at least a portion of their own information, such as his/her password.

The following example of the construction and operation of the MDB system 10 is set forth hereinafter. It is to be understood that the example is for illustrative purposes only and is not to be construed as limiting the scope of the invention as described and claimed herein.

### EXAMPLE 1

The MDB system 10 has the server 18 that includes a web server computer system which hosts a website on the Internet. Once the user 14 utilizes its user system 22 to initiate a web browser and connect to the server 18 via the website, the server 18 provides the user 14 with the user interface (implemented with PHP, JavaScript, Java Applet and HTML). The user interface is designed to facilitate and smooth the entire process of loading, storing, managing, linking, retrieving, analyzing, displaying and/or otherwise utilizing microarray research information to and from the MDB system 10, specifically for E. coli gene expression. The user interface is adapted to facilitate such functions by including a means for user management, project management, array production management, laboratory information management, data importation, data analysis, data visualization and data exportation.

Shown in FIG. 29 is a modular layout of the MDB system 10 for E. coli gene expression (however, the MDB system 10 can be tailored to any specific organism). There are four major components in the modular layout: a Front End section, a Project Management section, a Raw Data section, and a Microarray Platform section.

The Front End section to the MDB system 10 provides for data display and public access to E. coli data, and contains the Presentation module 430 and Production Data module 408. The Presentation module 430 contains the presentation, display, and analysis tools (e.g., cluster analysis, graphic displays, heat maps, etc.), and provides the user interface. As shown in FIG. 30, the user 14 is allowed to indicate a microarray experiment of interest. For example, the user 14 can select an experiment set and project from a project list for which the user 14 wants to perform a specific function. Here the user 14 is presented with several options for displaying experiment sets, such as for example receiving more information or creating a filter, a plot, a cluster analysis, a heat map, a genome view, a time series plot, a custom designed display, or an omics animation display.

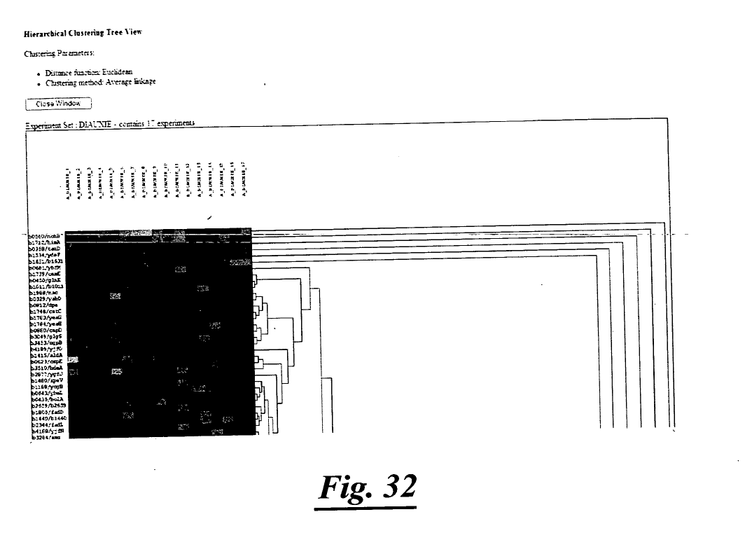

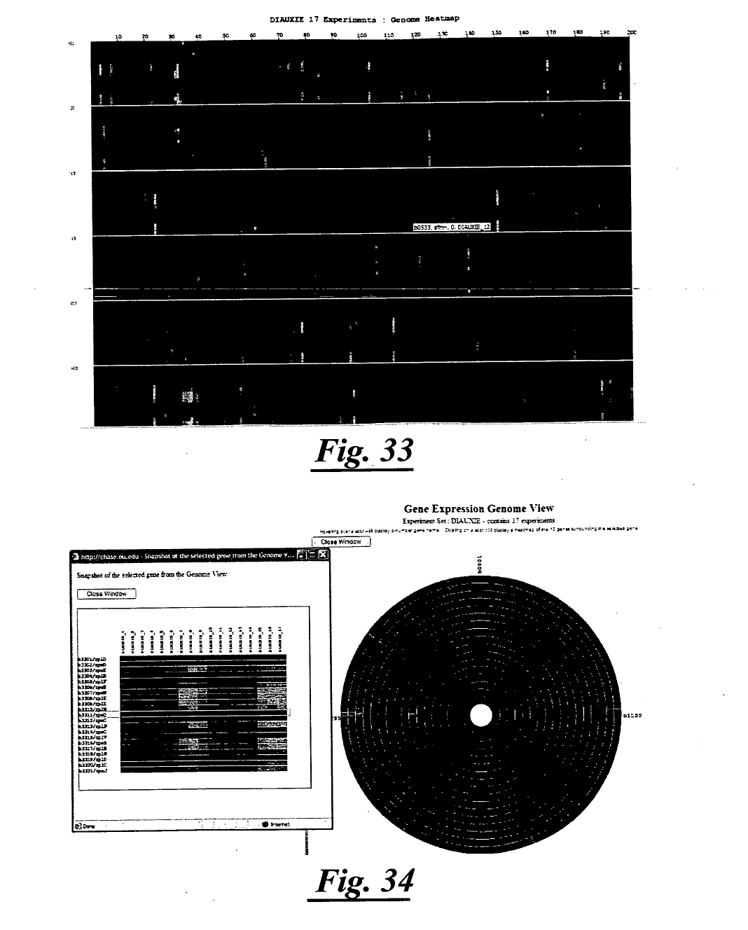

For example, the user 14 can plot the data according to statistical confidence intervals determined from the data, as shown for example in FIGS. 31A and 31B. The user 14 can display a hierarchical cluster of the chosen experiment set, as shown for example in FIG. 32. The user 14 can display the data in a heat map format that displays all genes by their order on the genome, in blocks of for example 200 genes, and each experiment in the Experiment Set on consecutive rows, as shown for example in FIG. 33. Mouse-over by the user 14 on the heat map displays the b-number, gene, ratio value, and Experiment for the selected data point, and clicking on the data point retrieves the gene-specific annotation information.

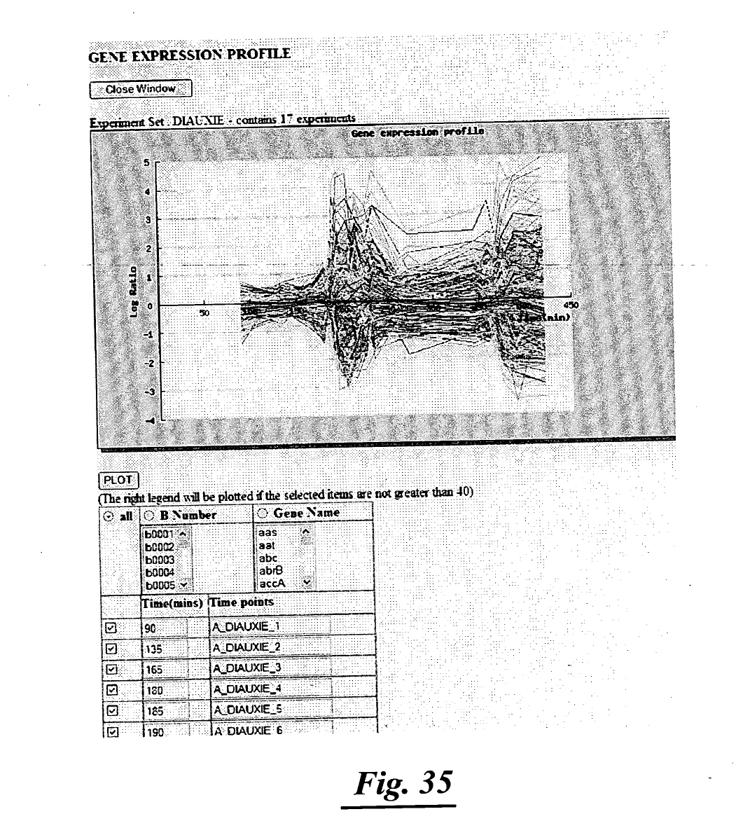

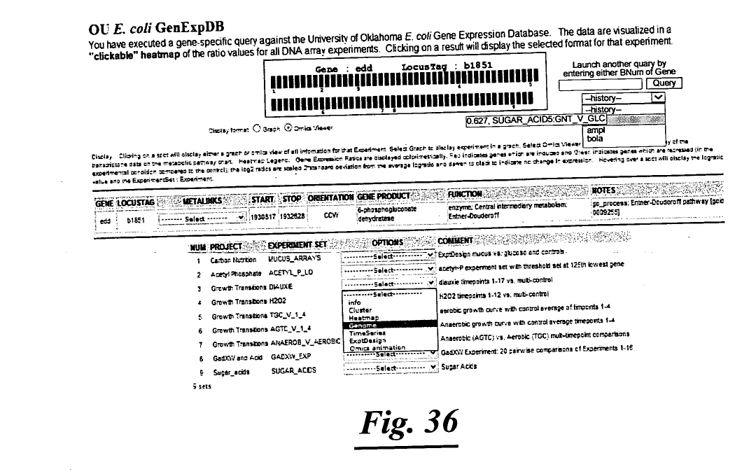

The user 14 can also display the data in Gene Expression Genome View (also a heat map format) which accommodates all genes in very large experiment sets to fit on a single page, as shown for example in FIG. 34. The genes are shown on mouse-over, and clicking opens a snapshot in a new window (insert) containing a detailed heat map for the gene, and further for the nearest genes, such as the twenty nearest genes for example. Further, the user 14 can display large experiment sets in log ratio vs. time point plots with each line representing an individual gene, as shown for example in FIG. 35. The data shown in FIG. 35 includes by way of illustration 4289 genes and 17 time points. However, the plot can be redrawn according to user-defined parameters. Further, the user 14 can go into the tool box and select experiments and/or experiment sets of their choice for display in the format of their choice.

Alternatively, the user 14 can enter a gene of their choice (e.g., using a gene name or b-number) in a gene query box, as also shown for example in FIG. 30, and then the gene-specific data for all available experiments can be displayed in a heat map format, as shown for example in FIG. 36 (where red is induced, green is repressed and black indicates no change). On mouse-over by the user 14 of the heat map, the experiment specific information is shown, as shown for example in FIG. 36. Gene-specific information from the annotation tables and meta-links to external databases can also be provided to the user 14, as shown for example in FIG. 36. Also, the project list discussed above can be displayed below the gene-information section, as shown in FIG. 36.

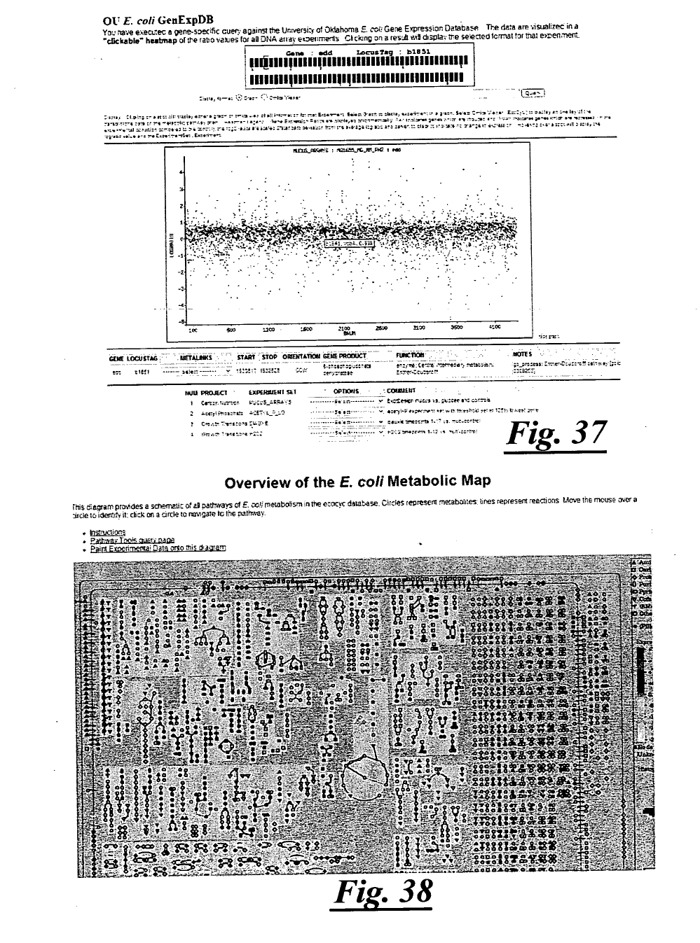

The user 14 further has the choice of displaying the entire experiment data as a ratio graph, as shown for example in FIG. 37. Mouse-over on the ratio plot reveals data for other genes, and if desired the user can execute a query for that gene by clicking the mouse. Further, the data can be displayed as an overlay on the E. coli metabolic pathway chart, for example using Pathway Tools (v9.0) written by EcoCyc programmers, as shown for example in FIG. 38.

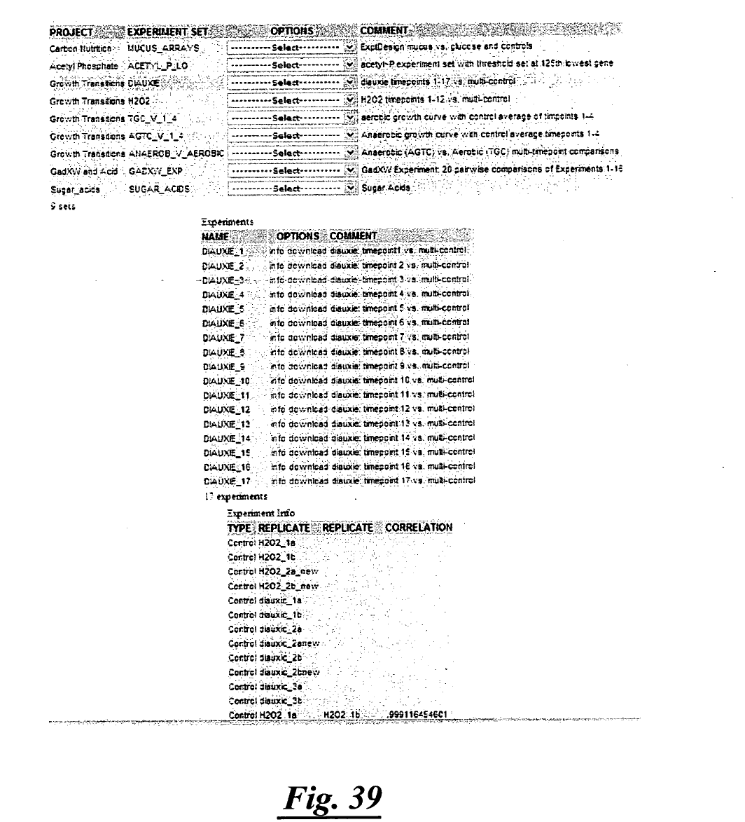

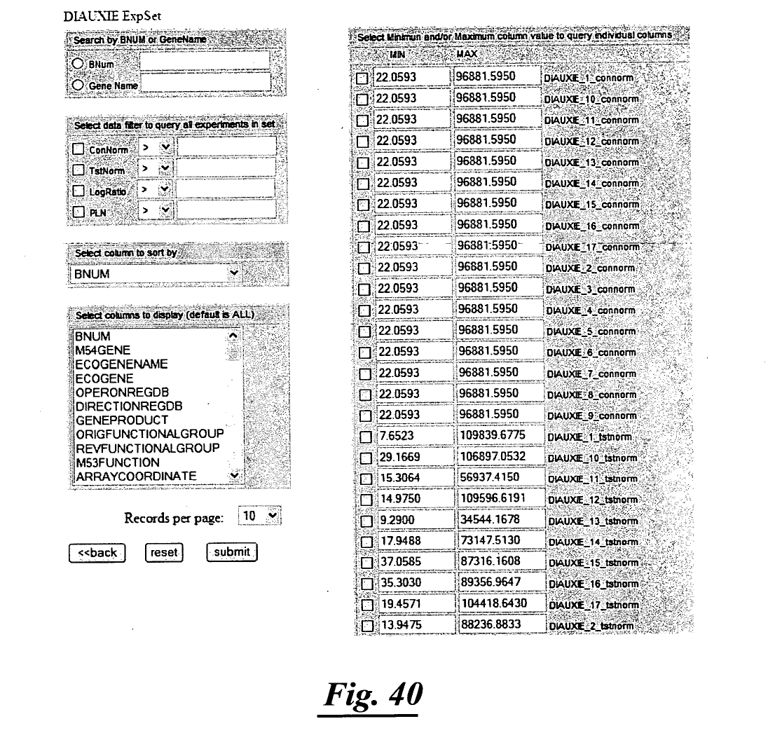

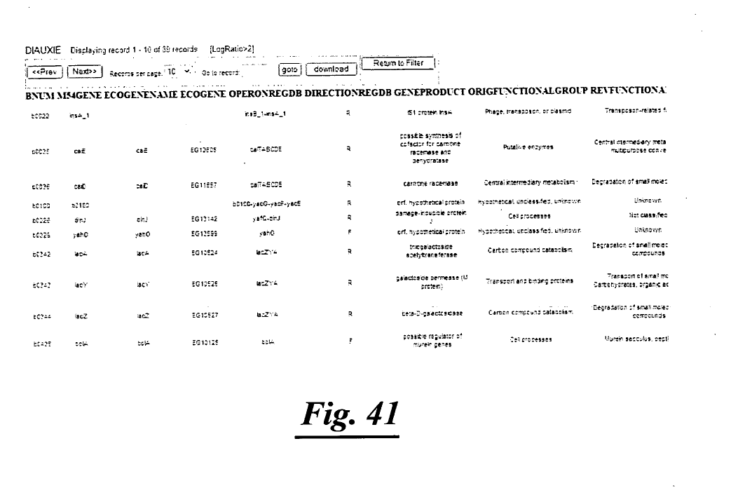

Also, the user interface is adapted to allow the user 14 to download the data for analysis in their favorite software package, as shown for example in FIG. 39. For example, the user 14 can down load data by clicking on an info option. Further, the user 14 can filter data by any of the available criteria, as shown for example in FIG. 40, and display the numerical data according to their filtering strategy, as shown for example in FIG. 41. The user 14 can also download the data in this format.

The Production Data module 408 contains the minimum information required for the presentation tools of the Presentation module 430, and is configured to facilitate integration of DNA array data generated on the most commonly used technology platforms (e.g., membranes, microarrays, and Affymetrix GeneChips). Preferably, the Production Data module 408 includes a database table designed to accommodate the most commonly accessed data fields, i.e., microarray intensity, ratio values, and confidence intervals, regardless of the technology platform used. Thus the MDB system 10 has the potential to handle proteome and metabolome data, provided that Preprocess Data, Raw Data, and Upload Data modules are programmed to interface with the specific application.

The purpose for the Production Data module 408 is two-fold. First, the data are stored in a common format that is standardized for the tools that can be accessed in the Presentation module 430. Second, accessing the data from the scaled-down Production Data module 408 with its minimum of data fields makes the tools operate much faster. These are huge advantages for displaying transcriptome data, as most databases do not truly integrate data generated on different platforms and are notoriously slow in display time because they access data from very large raw data tables. A schema for the Production Data module 408 is shown in more detail in FIG. 42.

The Project Management section contains four modules that correspond to intuitive levels of microarray experimentation. Replicate slides in an Experiment module 104 are preprocessed (i.e., normalized) and averaged to create an experiment. Experiments are usually associated in experiment sets (i.e., time points in a biological experiment or series of similar treatments) in the ExpSet module 102, and the experiment sets are associated with a project in the Project module 100, which is specific to the hypothesis being tested (i.e., related experiments published together in a single paper).

In the Raw Data Section, the Raw Data module 202 is the staging area for raw data storage and preprocessing of the data for integration into the Production Data module 208, which is specific to the technology platform and involves data filtering, normalization, scaling, etc., and conversion of the data to the common format employed for production data. Uploading data from the Upload Data module 200 into the Raw Data module 202 requires the user 14 to select from the Project Management section a preexisting Project/ExpSet/Experiment or create new ones as desired; in this way the higher level information is only entered once and does not need to be added every time Replicate microarray information is uploaded. Also, the LIMS and genome annotation are associated with the replicate experiments.

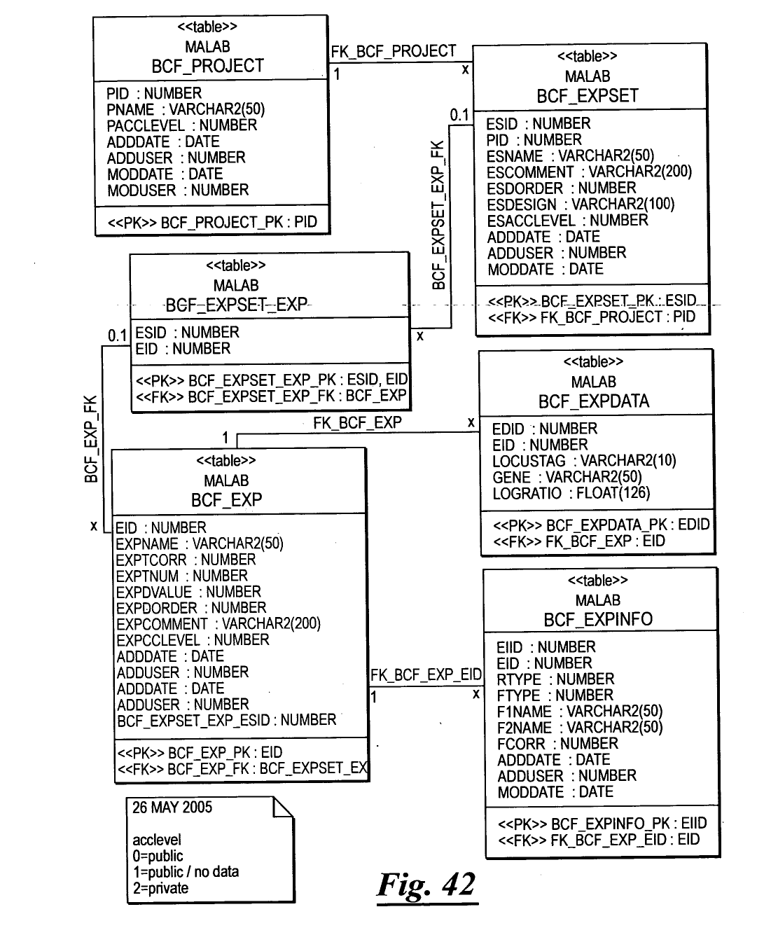

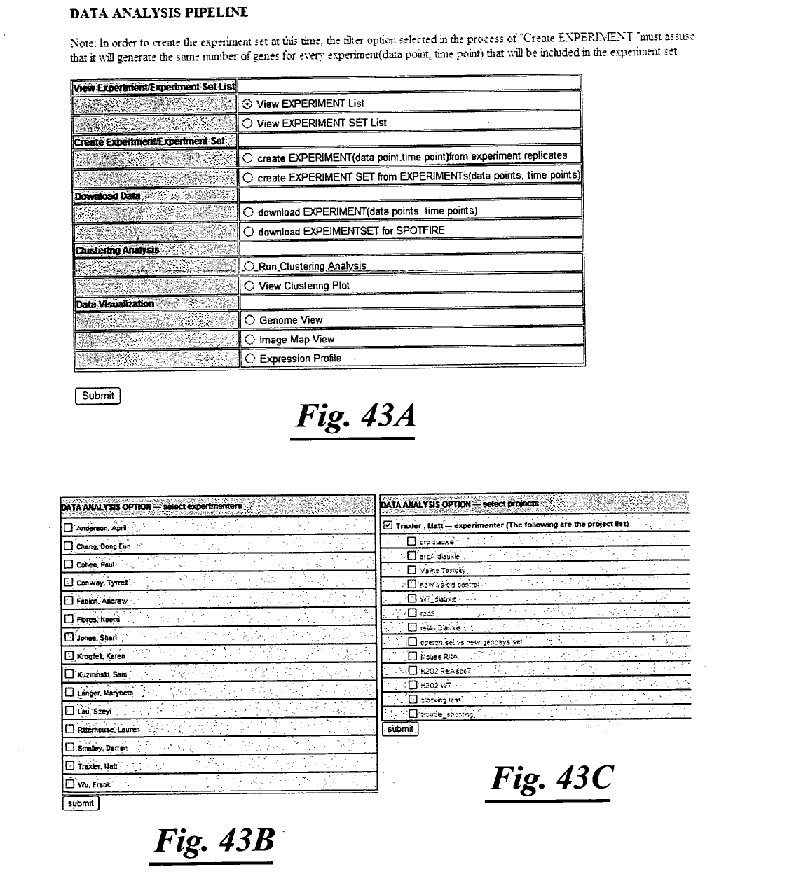

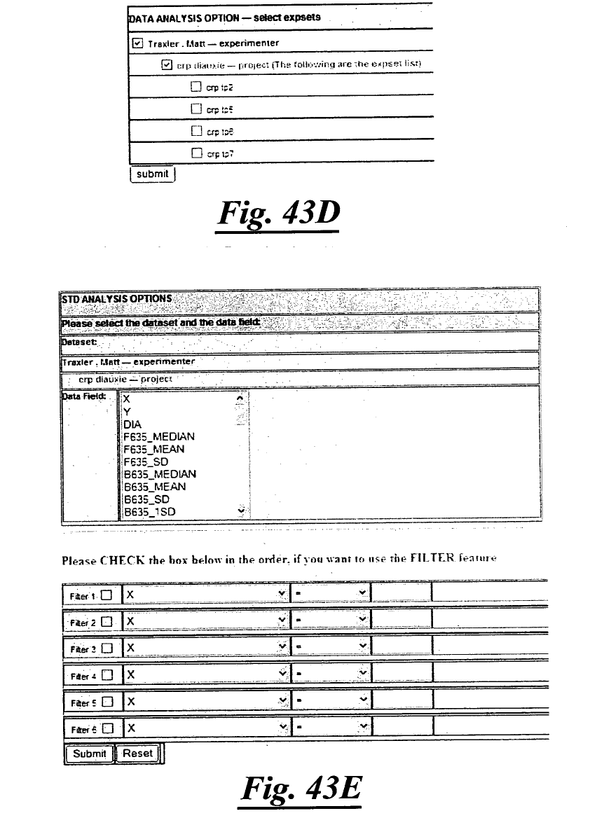

The user interface includes a “pipeline” structure that allows the user to create experiments from replicates and to group experiments into experiment sets for upload into the Production Data module 208, as shown for example in FIG. 43A. The pipeline not only allows novice users to preprocess the data for entry into the Production Data module 208 using standardized filtering and normalization protocols, but also sophisticated users can quickly enter a large number of replicates.

Within the user interface, the user 14 can select an option, i.e., Create Experiment, and chooses replicates to be preprocessed to create an experiment, which is associated with an experimenter (as shown in FIG. 43B), a project (as shown in FIG. 43C), and an experiment set (as shown in FIG. 43D). Clicking the Submit button sends the data into the pipeline, where options selected by the user 14 determine if and how the data is filtered and normalized during the pre-processing step, averaged, and used to calculate statistical metrics (as shown in FIG. 43E). The preprocessed data is then automatically entered into Production Data module 208.

The Microarray Platform section provides for collection, storage, and management of the information associated with the microarray production process, including print process management and array design that are specific to the microarray technology platform involved.

From the above description, it is clear that the present invention is well adapted to carry out the objects and to attain the advantages mentioned herein, as well as those inherent in the invention. For example, it can also be seen that the various applications of the MDB system 10 of the present invention guides the user 14 from the first step of a mircoarray experiment and goes through to the last step of analysis to provide reliability and reproducibility of results, identification of relationships to previous experiment results, and displays of functional aspects of the results. Robust microarray data management is envisioned to enhance, by eliminating information bottlenecks, disease diagnosis and prediction, genealogy, animal registration organizations, pharmaceutical development, detecting and managing bioterrorism threats.

Although the foregoing invention has been described in some detail by way of illustration and example for purposes of clarity of understanding, it will be apparent to those skilled in the art that certain changes and modifications may be practiced without departing from the spirit and scope of the present invention, as described herein. As such, those skilled in the art will appreciate that the conception upon which this disclosure is based may readily be utilized as a basis for the designing of other structures, methods, and systems for carrying out the several purposes of the present invention. As such, it should be understood that the invention is not limited to the specific and preferred embodiments described herein, including the details of construction and the arrangements of the components as set forth in the above description or illustrated in the drawings. Further, it should be understood that the phraseology and terminology employed herein are for the purpose of description and should not be regarded as limiting.

What is claimed is:

1. A computer based method for collecting, storing and integrating microarray information and tracking materials for a microarray experiment, the method comprising the steps of:
collecting array information indicative corresponding to the design and production of a microarray for the microarray experiment;
collecting experimental information indicative of the production of a sample and a hybridization process used with the microarray in microarray experiment;
collecting experiment results obtained from hybridization between the sample and the microarray in the microarray experiment; and
linking and integrating at least a portion of the array information, the experimental information, and the experiment results associated with the microarray experiment, wherein the array information, the experimental information and the experiment results are retrievable and combinable by access of any piece of information in the array information, the experimental information, and the experiment results.

2. The method of claim 1, wherein the step of linking and integrating at least a portion of the array information, the experimental information, and the experiment results for each microarray experiment further comprises, for an individual spot on the microarray of the microarray experiment, linking at least a portion of the array information, the experimental information, and the experiment results associated with the individual spot.

3. The method of claim 1, wherein the array information includes information indicative of at least one of an array design, a probe formation, a plate source, a location of a spot, a printing chemistry, a print-run, an array printer configuration, and a gene annotation for the microarray of the microarray experiment.

4. The method of claim 1, wherein the experimental information includes information indicative of at least one of a project, experiment set, biosample source, a biosample protocol, a biosample, a extract protocol, an extracted sample, a label protocol, a labeled extracted sample, a hybridization protocol, and a hybridization for the microarray experiment.

5. The method of claim 1, wherein the experiment results include information indicative of at least one of raw data and an array image obtained from hybridization between the sample and the microarray in the microarray experiment.

6. The method of claim 1, further comprising the steps:
generating analysis results utilizing at least a portion of the experiment results for the microarray experiment; and
linking and integrating at least a portion of the analysis results for the microarray experiment with at least a portion of the array information, the experimental information and the experiment results for the microarray experiment.

7. The method of claim 6, wherein the analysis results include information indicative of at least one of a normalization, a background subtraction, a filtering, a scaling, a noise determination, a correlation, a differential gene expression, a t-statistic analysis, a linear model and Empirical Bayes method analysis, a data table, a sorted data table, a background and foreground image, a scatter plot, a boxplot histogram, a log(R/G) box plot, an R or G box plot, a Cy3-Cy5 plot, a log (Cy3)-log (Cy5) plot, a M-A plot, a cluster analysis, a graphic display, and a heat map.

8. The method of claim 1, wherein the step of collecting experimental information comprises:
identifying whether repetitive information exists which is expected to be common between the experimental information for a new microarray experiment and the experimental information previously collected for a preexisting microarray experiment; and
if the repetitive information exists, automatically retrieving for the experimental information for the new microarray experiment the repetitive information from the experimental information collected for the preexisting microarray experiment.

9. The method of claim 1, further comprising the step of for a plurality of samples created for experimentation, storing an initial amount value for each sample which is indicative of an initial amount of the sample, and wherein the step of collecting experimental information comprises receiving a used amount value indicative of an amount of one of the samples used for the microarray experiment, and subtracting the used amount value from the initial amount value of the sample so as to determine a remaining amount of the sample.

10. A computer program product for collecting, storing and integrating microarray information and tracking materials for a microarray experiment, the computer program product comprising:
code for collecting array information, the array information corresponding to the design and production of a microarray for the microarray experiment;
code for collecting experimental information, the experimental information being indicative of the production of a sample and a hybridization process used with the microarray in the microarray experiment;
code for collecting experiment results, the experiment results being obtained from hybridization between the sample and each of the microarray in the microarray experiment; and
code for linking and integrating at least a portion of the array information, the experimental information, and the experiment results associated with the microarray experiment, wherein the array information, the experimental information and the experiment results are retrievable and combinable by access of any piece of information in the array information, experimental information and the experiment results.

11. The computer program product 10, further comprising code for linking and integrating, for an individual spot on the microarray of the microarray experiment, at least a portion of the array information, the experimental information, and the experiment results associated with the individual spot.

12. The computer program product 10, wherein the array information includes information indicative of at least one of an array design, a probe formation, a plate source, a location of a spot, a printing chemistry, a print-run, an array printer configuration, and a gene annotation for the microarray of the microarray experiment.

13. The computer program product 10, wherein the experimental information includes information indicative of at least one of a project, experiment set, biosample source, a biosample protocol, a biosample, a extract protocol, an extracted sample, a label protocol, a labeled extracted sample, a hybridization protocol, and a hybridization for the microarray experiment.

14. The computer program product 10, wherein the experiment results include information indicative of at least one of raw data and an array image obtained from hybridization between the sample and the microarray in the microarray experiment.

15. The computer program product 10, further comprising:
code for generating analysis results utilizing at least a portion of the experiment results for the microarray experiment; and
code for linking and integrating at least a portion of the analysis results for the microarray experiment with at least a portion of the array information, the experimental information and the experiment results for the microarray experiment.

16. The computer program product of claim 15, wherein the analysis results include information indicative of at least one of a normalization, a background subtraction, a filtering, a scaling, a noise determination, a correlation, a differential gene expression, a t-statistic analysis, a linear model and Empirical Bayes method analysis, a data table, a sorted data table, a background and foreground image, a scatter plot, a boxplot histogram, a log(R/G) box plot, an R or G box plot, a Cy3-Cy5 plot, a log (Cy3)-log (Cy5) plot, a M-A plot, a cluster analysis, a graphic display, and a heat map.

17. The computer program product of claim 10, wherein the code for collecting experimental information comprises:
code for identifying whether repetitive information exists which is expected to be common between the experimental information for a new microarray experiment and the experimental information previously collected for a preexisting microarray experiment, and if the repetitive information exists, automatically retrieving for the experimental information for the new microarray experiment the repetitive information from the experimental information collected for the preexisting microarray experiment.

18. The computer program product of claim 10, further comprising:
code for storing, for a plurality of samples created for experimentation, an initial amount value for each sample which is indicative of an initial amount of the sample
code for receiving a used amount value indicative of an amount of one of the samples used for the microarray experiment, and subtracting the used amount value from the initial amount value of the sample so as to determine a remaining amount of the sample.

19. A microarray database system for collecting, storing and integrating microarray information and tracking materials for a microarray experiment for a user, the user being associated with a user system, the microarray database system comprising:
a server in communication with the user system, the server comprising:
a means for receiving array information corresponding to the design and production of a microarray for a microarray experiment;
a means for receiving experimental information indicative of the production of a sample and a hybridization process used with the microarray in the microarray experiment;
a means for receiving experiment results obtained from hybridization between the sample and the microarray in the microarray experiment;
a means for linking and integrating at least a portion of the array information, the experimental information, and the experiment results associated with the microarray experiment;
a means for generating analysis results utilizing at least a portion of the experiment results for the microarray experiment; and
a means for displaying the analysis results to the user via the user system.

20. The system of claim 19, further comprising a means for linking and integrating, for an individual spot on the microarray of the microarray experiment, at least a portion of the array information, the experimental information, and the experiment results associated with the individual spot.
